(19) United States
(12) Patent Application Publication
(10) Pub. No.: US 2026/0289637 A1
(43) Pub. Date: Sep. 24, 2026

(54) SYSTEM

(71) Applicant: SoftBank Group Corp., Tokyo (JP)

(72) Inventor: Runa SAWAMURA, Tokyo (JP)

(73) Assignee: SoftBank Group Corp., Tokyo (JP)

(21) Appl. No.: 19/567,016

(22) Filed: Mar. 14, 2026

(30) Foreign Application Priority Data
Mar. 19, 2025 (JP) 2025-045061

(51) Int. Cl. G06Q 30/0601; G06N 3/0475; G06N 3/0499; G06N 3/09; G06T 3/40; G06V 10/25; G06V 20/70; H04N 1/60

(52) U.S. Cl. CPC G06Q 30/0631; G06N 3/0475; G06N 3/0499; G06N 3/09; G06T 3/40; G06V 10/25; G06V 20/70; H04N 1/60

(57) ABSTRACT

A system includes a processor that is configured to provide an interface for receiving image data from a user, analyze the received image data to extract a characteristic of the user, and generate, by using a generative artificial intelligence model, a prompt based on the characteristic of the user, the prompt instructing selection of a product.

### CROSS-REFERENCE TO RELATED APPLICATION

This application is based on and claims priority under 35 USC 119 from Japanese Patent Application No. 2025-045061 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional online product recommendation systems generally rely on explicitly provided user profile information, such as age, gender, and purchase history, or on manually input preferences. As a result, such systems often fail to accurately reflect real-time and implicit user characteristics, for example, visual appearance features extracted from images of the user. In addition, when a user provides an image, conventional systems typically do not effectively convert the visual characteristics of the user into a structured query or prompt suitable for selecting products. This can lead to recommendations that are generic, not well-personalized, or not visually compatible with the user's actual traits. Furthermore, users frequently desire to confirm, in a visual manner, how recommended products might appear or be represented, but existing systems do not consistently provide such visual information in a seamless, integrated workflow. Accordingly, there is a need for a system that can receive image data from a user, automatically analyze the image data to extract user characteristics, convert the extracted characteristics into a prompt using a generative artificial intelligence model to direct product selection, and provide visual information of the selected products to a terminal of the user so that the user can visually confirm the products.

### SUMMARY

In order to solve the above-described problems, an aspect of the present invention provides a system comprising a processor, wherein the processor is configured to provide an interface for receiving image data from a user, analyze the received image data to extract a characteristic of the user, and generate, by using a generative artificial intelligence model, a prompt based on the characteristic of the user, the prompt instructing selection of a product. In one embodiment, the processor is further configured to search a database for related product information based on characteristic information of the user, which may include features extracted from the image data. By automatically converting visual user characteristics into a prompt tailored for product selection, the system can obtain product candidates from the database that more precisely match the user's appearance and needs. In another embodiment, the processor is configured to transmit visual information of the selected product to a terminal of the user so that the user can visually confirm the product. Through this configuration, the user can seamlessly receive, review, and visually evaluate product recommendations derived from the user's own image data, thereby improving the relevance, usability, and user satisfaction of the product recommendation process.

The term “system” refers to an integrated combination of hardware, software, and communication components that collectively execute processing for receiving user image data, analyzing user characteristics, generating prompts, and selecting and presenting product information.

The term “processor” refers to one or more hardware processing units, such as a central processing unit (CPU), graphics processing unit (GPU), or dedicated accelerator, which execute instructions to perform the functions described in the claims, including image analysis, prompt generation, database searching, and data transmission.

The term “interface” refers to a hardware and/or software component that enables input and output of data between the system and external entities, including user devices, and that is used to receive image data and to transmit product-related information.

The term “image data” refers to digital data representing a still image or a frame of a moving image, such as a photograph of a user's face, body, or other relevant scene, encoded in a format including, but not limited to, JPEG, PNG, or HEIF.

The term “user” refers to an individual person who operates a terminal or other device to provide image data to the system and to receive product recommendations and visual

The term “characteristic of the user” refers to a feature or attribute derived from the image data of the user, including, for example, skin type, facial features, body shape, personal color, style preference, or any other appearance-related or visually inferable trait.

The term “generative artificial intelligence model” refers to a machine learning model configured to generate outputs, such as text, images, or other content, based on input data, and including, for example, large language models, diffusion models, or other generative models capable of producing a prompt from extracted user characteristics.

The term “prompt” refers to a data structure, typically in textual or tokenized form, generated by the generative artificial intelligence model, which encodes instructions or constraints to be used for selecting one or more products from a database or other source.

The term “product” refers to a good or service, including but not limited to cosmetic items, skincare products, apparel, accessories, or digital services, that can be recommended to the user based on the user's characteristics.

The term “characteristic information of the user” refers to information representing one or more characteristics of the user, including characteristics extracted from image data and optionally combined with other user-related data, and used as a basis for searching for related product information.

The term “database” refers to a structured collection of data stored on one or more storage devices, which stores product information, including attributes, images, and metadata, and which can be searched based on characteristic information of the user or prompt data.

The term “product information” refers to information associated with a product, including product name, category, specifications, color, size, price, branding, usage instructions, availability, and related metadata.

The term “selected product” refers to at least one product that has been identified or chosen by the system, based on the prompt and characteristic information of the user, as suitable for recommendation to the user.

The term “visual information of the selected product” refers to image data or other graphical representations related to the selected product, such as product photographs, rendered images, icons, or simulated appearance images, which are suitable for display on a user terminal.

The term “terminal of the user” refers to an electronic device operated by the user, such as a smartphone, tablet, personal computer, or wearable device, which is capable of communicating with the system via a network and of displaying product-related information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

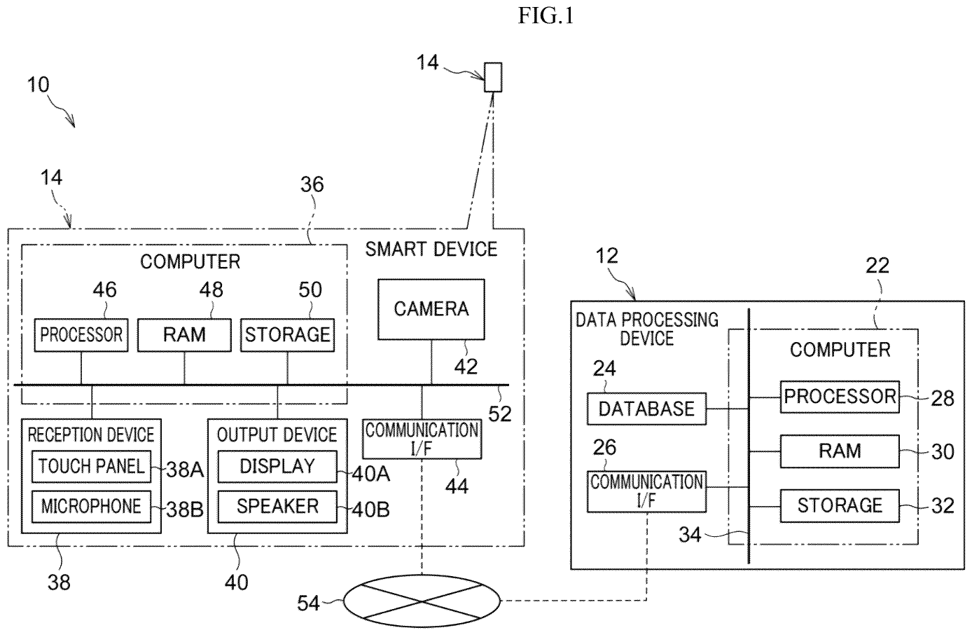

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

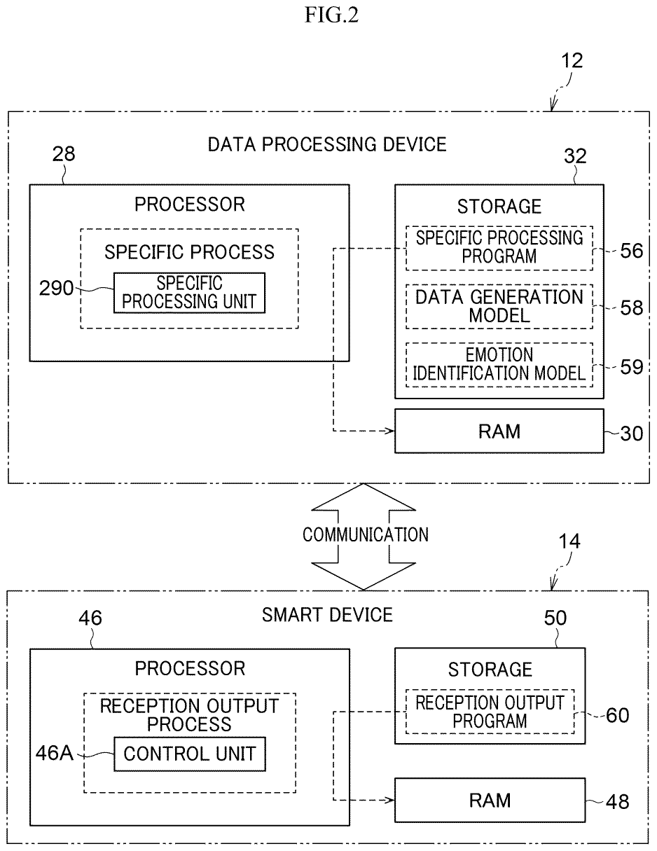

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented product recommendation systems typically rely on coarse user attributes such as age, gender, or past purchase history, and therefore fail to fully leverage the rich visual information contained in user-provided images. As a result, such systems often generate recommendations that are only loosely correlated with the user's actual appearance, skin condition, or context of use, thereby reducing user satisfaction and engagement.

Furthermore, in many existing architectures, image analysis, user trait extraction, and recommendation logic are implemented as loosely coupled or manually configured components. A processor in such systems may simply pass raw or lightly processed outputs of an image analysis engine into a generic recommendation engine, without a structured mechanism for encoding user traits and situational context into a form that can be effectively consumed by a generative artificial intelligence model. This leads to inefficient utilization of computational resources and an inability to systematically adapt the content of prompts or queries to the underlying model.

In addition, conventional systems do not provide a unified computational framework in which low-level color features and face region information are converted, within the same server-side processing pipeline, into higher-level trait information such as skin condition and appearance color attributes, which are then automatically reflected in dynamically generated prompt sentences. Without such a framework, the processor cannot consistently perform end-to-end optimization of data flow, model invocation, and response formatting, leading to latency issues, increased development complexity, and suboptimal personalization.

Moreover, existing systems often require manual curation or static rule sets for mapping appearance-related information to product categories and visual presentations. This manual intervention limits scalability and prevents the system from fully exploiting the inference capabilities of modern generative artificial intelligence models. It also makes it difficult to maintain a consistent structure between model outputs, product database contents, and visual information ultimately rendered on user terminals.

Accordingly, there is a need for an improved computer-based system and server-side processing architecture in which a processor is configured to: (i) receive image information and situation information from user terminals; (ii) invoke external image analysis functionality to obtain color feature information and face region information; (iii) extract user characteristic information including skin condition information and appearance color attribute information; (iv) automatically generate context-aware prompt sentences for a generative artificial intelligence model; (v) obtain structured product candidate information from the model; and (vi) convert such information into recommendation product information and associated visual data that can be efficiently transmitted to and displayed on user terminals. Such a system should improve the way computer resources are orchestrated to process image-derived traits and situational context, resulting in more accurate, efficient, and scalable personalization.

The specific processing by the specific processing unit 290 of the data processing device 12 in Example 1 is realized by the following means.

The present invention provides a server comprising a processor configured to receive, via a communication interface, image information and situation information from a user terminal through a communication network; to execute an image analysis process on the image information by using an external image analysis function to obtain color feature information and face region information; to extract user characteristic information including skin condition information and appearance color attribute information based on the color feature information and the face region information; to generate, on the basis of the user characteristic information and the situation information, a prompt sentence to be input to a generative artificial intelligence model by combining template information with the user characteristic information and the situation information through a text generation process; to input the prompt sentence into the generative artificial intelligence model and, based on numerical computation performed by the generative artificial intelligence model, obtain product candidate information including clothing product information, cosmetic product information, and skin care product information; to select, based on attribute information included in the product candidate information, a plurality of product information items from a group of product information stored in a storage device, and to structure the plurality of product information items as recommendation product information associated with the product candidate information; to acquire image information corresponding to the recommendation product information from the storage device and format the recommendation product information and the image information as response information transmittable to the user terminal; and to transmit the response information to the user terminal so that the recommendation product information and the image information are presented to a user through the user terminal. This enables an integrated and technically improved processing pipeline in which a computer system efficiently transforms raw image data and situational context into structured prompt sentences, leverages a generative artificial intelligence model in a machine-optimizable format, and automatically produces personalized recommendation content and associated visual information with reduced latency, improved utilization of computational resources, and enhanced relevance of recommendations from the perspective of computer-implemented data processing.

The term “system” refers to a combination of hardware and software components including at least one processor, one or more memories, and one or more communication interfaces that cooperate to perform the operations described in the claims.

The term “processor” refers to one or more hardware-based processing units, such as a central processing unit, a graphics processing unit, a digital signal processor, or any combination thereof, configured to execute instructions to perform data processing operations.

The term “server” refers to a computing apparatus or a group of computing apparatuses, including the processor and associated resources, that provides services such as data processing, storage, and communication to one or more user terminals over a communication network.

The term “communication interface” refers to a hardware and software combination that enables the server to send and receive data over a communication network, including but not limited to network interface controllers, modems, and communication protocol stacks.

The term “user terminal” refers to any electronic device operated by a user, such as a smartphone, a tablet, a personal computer, or a similar device, that is capable of capturing, transmitting, and displaying information over a communication network.

The term “communication network” refers to any wired or wireless network infrastructure, including the internet, local area networks, wide area networks, cellular networks, or combinations thereof, used for transmitting data between the server and the user terminal.

The term “image information” refers to digital data representing visual content, including but not limited to still images and moving images, that is captured, stored, or transmitted in an electronic form.

The term “situation information” refers to context information provided by the user or otherwise obtained, including but not limited to event type, occasion, usage scene, or similar descriptive data indicating an intended use context for product recommendations.

The term “external image analysis function” refers to a software-implemented image processing or recognition service, executable locally or as a remote service, that receives image information and outputs analysis results such as detected regions, labels, or feature values.

The term “image analysis process” refers to a sequence of computational operations applied to image information using the external image analysis function to derive analysis results including color feature information and face region information.

The term “color feature information” refers to data representing color-related characteristics extracted from image information, including but not limited to color values, color histograms, dominant colors, saturation, brightness, or other numerical color descriptors.

The term “face region information” refers to data indicating one or more spatial regions within the image information that correspond to a human face, including coordinates, bounding boxes, masks, or similar positional indicators.

The term “user characteristic information” refers to information derived from the image analysis process that represents traits of the user, including at least skin condition information and appearance color attribute information, and optionally other appearance-related attributes.

The term “skin condition information” refers to information indicating a state or type of the user's skin, such as dryness level, oiliness level, sensitivity, or similar characteristics inferred from the image information or related data.

The term “appearance color attribute information” refers to information representing a classification or category of the user's appearance in terms of color characteristics, including but not limited to categories based on color tone, brightness, saturation, or seasonal-type groupings.

The term “template information” refers to predefined text patterns, structures, or fragments that include variable fields into which user characteristic information and situation information are inserted to form a complete prompt sentence.

The term “text generation process” refers to a sequence of computational operations performed by the processor to combine template information with user characteristic information and situation information so as to produce a natural-language text string.

The term “prompt sentence” refers to a natural-language text generated by the text generation process and intended as an input to a generative artificial intelligence model to instruct the model to perform a specified task.

The term “generative artificial intelligence model” refers to a machine-learned model configured to generate data, including text or structured information, in response to an input such as a prompt sentence, by performing numerical computations on internal parameters.

The term “numerical computation” refers to operations including but not limited to matrix multiplications, vector operations, nonlinear transformations, and probabilistic inference, executed by the processor or a hardware accelerator in order to evaluate the generative artificial intelligence model.

The term “product candidate information” refers to information output from the generative artificial intelligence model that describes one or more candidate products, including identifiers, categories, attributes, or textual descriptions of products.

The term “clothing product information” refers to product candidate information relating to apparel or garments, including categories, styles, colors, sizes, and other clothing-related attributes.

The term “cosmetic product information” refers to product candidate information relating to makeup or beauty products, including product types, colors, finishes, or usage purposes.

The term “skin care product information” refers to product candidate information relating to products applied to the skin for care or treatment, including moisturizers, cleansers, lotions, serums, or similar preparations.

The term “storage device” refers to any non-transitory computer-readable medium, including but not limited to magnetic storage, optical storage, semiconductor memory, or network-attached storage, used to store product information, image information, and other data.

The term “product information” refers to data describing a product, including at least a product identifier, category, attributes, textual description, and optionally pricing information and associated image information.

The term “product information group” refers to a set or collection of product information items stored in the storage device and available for selection by the processor.

The term “attribute information” refers to information indicating characteristics of a product, such as category, color, material, skin type suitability, usage scene, or other descriptive attributes.

The term “recommendation product information” refers to a subset of product information items selected from the product information group and structured as a recommendation result associated with the product candidate information.

The term “response information” refers to data formatted by the processor for transmission to the user terminal, including the recommendation product information, related image information, and any additional presentation metadata.

The term “classification function” refers to a software-implemented or hardware-implemented function that receives feature information as input and outputs a classification result assigning the input to one of a plurality of predefined categories.

The term “color attribute category” refers to one of multiple predefined categories representing color-based groupings, such as groups defined by hue, tone, saturation, or similar color-related criteria.

The term “expression content” refers to specific wording, phrasing, or textual structure used in the prompt sentence or other generated text as presented to or used for processing by the system.

The term “product type” refers to a category or class of products, such as clothing, footwear, skincare, or cosmetics, used to organize or filter recommendations.

The term “visual information” refers to any image information, including still images and moving images, that visually represents a product or a product coordination recommended by the system.

The term “still image information” refers to visual information in the form of static images, such as photographs, rendered images, or graphics.

The term “moving image information” refers to visual information in the form of motion pictures or video content, including sequences of frames representing products or product usage.

The term “display function” refers to a capability of the user terminal, implemented via hardware such as a display panel and associated software, to render visual and textual information for viewing by the user.

In one embodiment, a server operates as a network-connected computing node that executes a program for generating personalized product recommendations based on image information and situation information received from a user. The server comprises at least one central processing unit (CPU), an optional graphics processing unit (GPU) or tensor processing unit (TPU) for accelerating machine-learning computations, a main memory, a non-transitory storage device, and a communication interface. The server executes software components implemented, for example, using a web application framework such as a general-purpose HTTP server, a machine-learning framework such as a tensor-based numerical computation library, and an image analysis client library for accessing an external image recognition service.

The terminal operates as a user-operated device such as a smartphone, a tablet, or a personal computer. The terminal executes a messaging application that communicates with the server over a communication network using a secure transport protocol. The terminal includes an image capture component such as a camera, a local storage subsystem, and a display device for rendering text and images. The terminal enables the user to capture or select images (for example, a face photograph or a full-body photograph) and to input situation information as text (for example, an intended event or usage scene).

The user operates the terminal to provide image information and situation information. The user selects a face image or a full-body image from the terminal's storage or captures a new image using the camera. The user optionally inputs situation information in natural language, such as “parent-teacher meeting,” “formal evening party,” or “business casual conference.” The terminal then transmits the image information and situation information to the server through the communication network using an application-level message format.

The server uses the communication interface to receive the image information and situation information from the terminal. The server stores the received image information in the storage device, for example, in a dedicated image repository, and stores the situation information and metadata in a relational data structure within a database. The database may be configured as a table including fields such as user identifier, session identifier, image path, upload timestamp, situation text, and processing status. By structuring the stored data in this manner, the server improves data management and supports efficient retrieval and correlation between images, user traits, and generated recommendations.

The server applies an image preprocessing module implemented using an image-processing library such as a general-purpose computer-vision toolkit. The server decodes the received image into a pixel matrix, normalizes the resolution to a predetermined size, and converts the color space to a standardized format such as sRGB. The server may also crop regions outside a detected bounding box to reduce noise. These preprocessing operations produce a normalized tensor representation of the image that improves the stability and speed of subsequent image analysis and model inference.

The server uses an external image analysis function, implemented for example as a cloud-based image recognition service accessed through an application programming interface, to perform an image analysis process on the normalized image tensor. The server transmits the image data or a reference location to the external image analysis function and receives analysis results in a structured response format. The analysis results include color feature information, such as histograms of dominant colors, brightness distribution, and saturation distribution, and face region information, such as coordinates of a detected face region and facial landmarks.

The server executes a trait-extraction module that transforms the color feature information and face region information into user characteristic information. The server uses a combination of rule-based logic and a trained classification model to infer skin condition information (for example, dry, oily, or combination) from brightness variability, highlight distribution, and contrast between skin regions. The server uses another classification model to determine appearance color attribute information (for example, seasonal-type categories) from normalized color vectors of skin, hair, and other visible features. In one embodiment, the classification models are implemented as feedforward neural networks trained using a supervised learning method with a cross-entropy loss function and stochastic gradient descent or an adaptive optimization algorithm to update weights. By executing trait extraction in this way, the server converts low-level image features into high-level structured attributes that can be efficiently reused and indexed, which improves both accuracy and computational efficiency compared to repeated raw-image analysis.

The server stores the user characteristic information in association with the session identifier in the database. The user characteristic information is represented as a structured record, for example including fields such as skin_condition_type, appearance_color_category, and confidence_scores. This structuring enables the server to apply downstream logic that filters and personalizes recommendations based on trait values without reprocessing images, which reduces overall processing time and communication load to the external image analysis function.

The server executes a prompt-generation module that produces a prompt sentence to be input into a generative AI model. The server maintains template information that defines multiple text patterns, each pattern including placeholder fields for user characteristic information and situation information. The server selects an appropriate template based on the presence or absence of specific traits and situation descriptors. For example, when both skin condition information and appearance color attribute information are available, the server may use a template that explicitly mentions both traits and the situation. The server then replaces the placeholders with the extracted trait values and the normalized situation text to form a coherent natural-language prompt sentence.

The server may generate, for example, a prompt sentence such as:

“The user has dry skin and a Spring personal color. The user is attending a parent-teacher meeting. Based on these traits, propose a full-body outfit coordination in pastel tones and recommend suitable skincare and makeup products that are gentle on dry skin.” In another example, the server may generate a prompt sentence such as:

“The user has oily skin and a Winter personal color and will attend an evening wedding party. Please generate a detailed coordination including dress style, color scheme, accessories, and long-lasting makeup products appropriate for an elegant Winter-type look.” The server executes a generative AI module implemented using a tensor-based numerical computation library. In one embodiment, the generative AI model is a Transformer-based neural network consisting of an encoder-decoder architecture or a decoder-only architecture with multiple attention layers. The model parameters include token embeddings, positional encodings, multi-head attention weights, and feedforward layer weights. The server tokenizes the prompt sentence into a sequence of token identifiers using a predetermined vocabulary, maps the tokens into embedding vectors, and feeds the embedding sequence into the generative AI model. The model performs numerical computations including matrix multiplications, layer normalization, and non-linear activation functions such as rectified linear units or variants. The server executes these computations on the CPU or offloads them to the GPU or TPU to improve inference speed.

The server configures the generative AI model to output product candidate information in a structured textual or semi-structured format. In one embodiment, the model is trained to produce an output that encodes product categories, attributes, and coordination rules using a constrained grammar, such as key-value pairs or list-like segments separated by special tokens. During training, the server or a training environment uses a dataset of example prompt sentences and target recommendation descriptions, optimizes a sequence-to-sequence loss function, and updates model weights using backpropagation. The training process may include data augmentation techniques such as synonym replacement in situation text or controlled variation of trait combinations to improve generalization and robustness.

The server interprets the output of the generative AI model by parsing the generated text according to the constrained grammar. The server identifies product candidate entries, each entry including at least a product category (for example, suit, dress, moisturizer, lipstick), color preferences, and usage constraints (for example, suitable for dry skin, appropriate for indoor formal events). The server converts these entries into a structured internal data structure with fields for category, color, skin_type_compatibility, occasion, and other attributes. This structured representation allows efficient filtering and matching against a product information group stored in the storage device.

The server queries a product information group maintained in the storage device. The product information group is stored as one or more database tables or indexed documents, each record or document representing a product with fields such as product_id, category, color_code, skin_type_applicability, occasion_tags, description, price, and image_reference. The server uses the attributes extracted from the product candidate information as query conditions, for example, selecting products where the category matches the recommended category, the color_code aligns with the recommended color attribute, and the skin_type_applicability includes the inferred skin condition. The server may also apply a scoring algorithm that combines similarity measures between candidate attributes and product attributes, weighting critical factors such as skin compatibility and color coordination.

The server selects a subset of products as recommendation product information. The server structures the recommendation product information as a composite object, for example, including a coordinated outfit composed of multiple clothing items, plus associated skincare and cosmetic products. The server may compute an overall coordination score based on the generative AI model's output probabilities and the database-matching scores, and select the combination with the highest score or several top-ranked combinations. This selection process improves the precision of recommended products compared to simple rule-based systems, because it exploits both model inference and database-level attribute matching. The server retrieves visual information corresponding to the selected products. The server accesses image_reference fields in the product records to obtain image identifiers or storage locations. The server then loads the corresponding still image information or moving image information from an image repository or content delivery subsystem. In certain embodiments, the server may also generate composite visual representations of full outfits using an additional image composition module, which arranges individual product images according to predefined layout rules. By assembling visual information server-side, the server reduces the amount of layout logic required on the terminal and ensures consistent presentation. The server formats the recommendation product information and the visual information as response information suitable for transmission to the terminal. The server constructs a response structure that includes textual descriptions of each recommended product, trait-based rationales (for example, “selected for dry skin and Spring personal color”), and associated image identifiers or URLs. The server may compress the response payload or select image resolutions according to the terminal type or network conditions, thereby reducing communication load and improving response time.

The terminal receives the response information from the server via the communication network. The terminal decodes the response according to the application protocol and renders the recommendation product information and visual information on the display. The terminal presents text descriptions, images, and any interactive elements (such as buttons or links) that allow the user to view more details or transition to external pages. The user can visually inspect the recommended products and, if desired, initiate further actions such as refining the situation information or requesting alternative looks.

The server, by integrating the above-described modules, achieves technical improvements beyond mere automation of human tasks. The server reduces overall processing latency by performing image analysis once and caching user characteristic information for reuse across multiple recommendation sessions. The server improves recommendation precision by combining external image analysis outputs, trait classification, and generative AI inference using structured intermediate representations and explicit attribute matching. The server reduces network load by transmitting normalized image data to the external image analysis function only once per image and by tailoring response payloads to terminal capabilities.

The generative AI model contributes to computational efficiency and accuracy by encoding complex, nonlinear relationships between user traits, situations, and product combinations into a parameterized neural network. The server uses this model to perform rapid inference via matrix operations optimized on specialized hardware, which is not practically achievable by manual rules or conventional linear models. During training, the server or a training system applies regularization techniques, mini-batch processing, and parameter updates guided by an error function that measures divergence between generated recommendations and expert-curated target recommendations. This training regime enables the generative AI model to discover latent coordination rules that are difficult to encode manually.

The server employs decision logic that is distinct from traditional human decision-making processes. For example, the trait-extraction module determines skin condition from statistical distributions of pixel intensities and color variance across facial regions, rather than from subjective visual inspection. The appearance color attribute classification uses normalized color vectors and learned weights in a neural network to assign categories, allowing subtle color relationships to be modeled more finely than in coarse human-defined rules. The prompt-generation module uses different templates and dynamically inserts trait and situation information to produce structurally consistent instructions that maximize the generative AI model's predictive performance.

The system, as implemented by the server, thereby improves computer technology by defining specific data structures (normalized image tensors, trait records, structured product candidates, and recommendation objects), by orchestrating specialized processing modules (external image analysis, trait extraction, template-based prompt generation, generative AI inference, and database matching), and by leveraging hardware acceleration for numerical computations. These technical arrangements lead to measurable improvements in processing speed, prediction accuracy, and resource utilization. As a result, the system enables a computer to perform an end-to-end transformation of raw image data and context information into actionable, visually supported recommendations in a manner that is more efficient and precise than conventional architectures relying on separate, loosely integrated components or static rule sets.

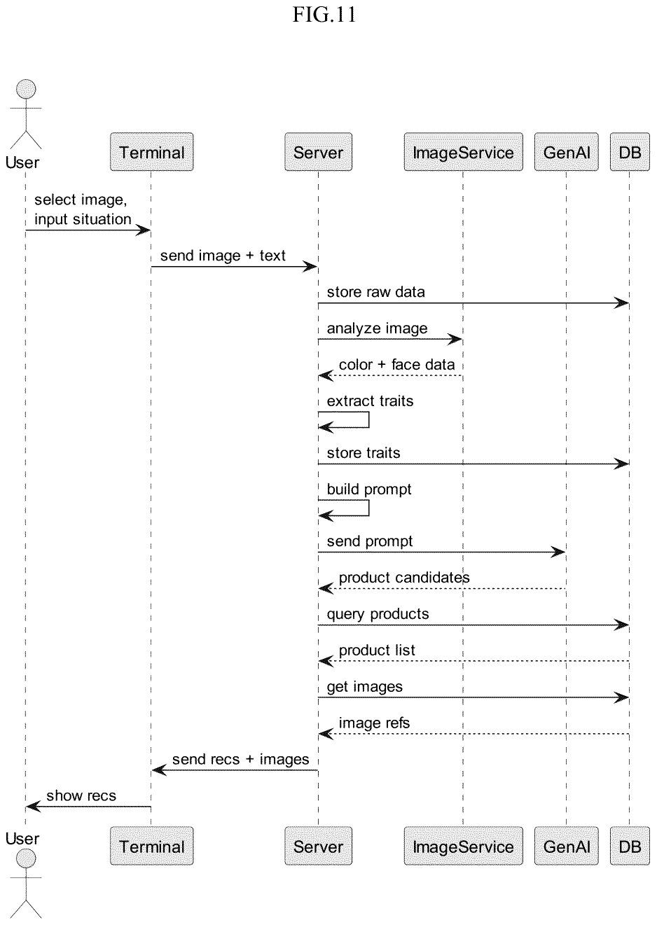

The following describes the processing flow using FIG. 11.

### Step 1:

The user operates the terminal to prepare input data.

The user captures a new image with the terminal's camera or selects an existing face or full-body image from the terminal's local storage and optionally enters situation information as free text (for example, “parent-teacher meeting” or “evening wedding party”).

Input: A raw image file stored on the terminal and optional situation text entered by the user.

Output: A message payload on the terminal containing the image file and the situation text, ready for transmission to the server.

Step 2: The terminal transmits the message payload to the server.

The terminal packages the image file and the situation text into a request according to a messaging or HTTP-based protocol and encrypts the data using a secure transport protocol such as TLS. The terminal sends the request to a predefined server endpoint over a communication network.

Input: The message payload containing image data and situation text on the terminal.

Output: An encrypted network request sent from the terminal to the server, containing the image data and situation information.

### Step 3:

The server receives and stores the raw input data.

The server accepts the incoming request via a communication interface, validates headers and payload format, and verifies any authentication token included in the request. The server writes the image bytes to a storage device as an image file and inserts a database record that links a session identifier, the image file path, a timestamp, and the situation text.

Input: The encrypted network request containing image data and situation text.

Output: A stored image file in the storage device and a corresponding database record referencing the image path and situation text.

### Step 4:

The server performs image preprocessing.

The server loads the stored image file into memory and uses an image-processing library to decode the bytes into a pixel matrix. The server resizes the matrix to a standard resolution (for example, 1024×1024 pixels), converts the color space to a standard format such as sRGB, and optionally crops or pads the image to maintain aspect ratio. The server then generates a normalized image tensor suitable for further analysis.

Input: The stored image file referenced by the database record.

Output: A normalized image tensor in memory along with updated metadata (for example, width, height, color space) associated with the session.

### Step 5:

The server calls an external image analysis function.

The server sends the normalized image tensor or an encoded version of the image to an external image analysis service via an API request, specifying that color feature information and face region information are required. The server waits for the API response and then parses the structured response data.

Input: The normalized image tensor and API request parameters indicating analysis types.

Output: Color feature information (for example, dominant colors, histograms, brightness values) and face region information (for example, bounding boxes and landmarks) stored as structured data.

### Step 6:

The server extracts user characteristic information from the analysis results.

The server applies transformation logic to the color feature information and face region information. The server computes statistical measures such as mean brightness, variance, and color distribution in the face region, and uses these measures as feature vectors. The server inputs the feature vectors into a trained classification model or applies rules to determine skin condition information (such as “dry” or “oily”) and appearance color attribute information (such as “Spring” or “Winter”).

Input: Color feature information and face region information from the external image analysis function.

Output: User characteristic information including at least skin condition information and appearance color attribute information, stored as a structured trait record.

### Step 7:

The server normalizes and stores the user characteristic information.

The server assigns standardized codes to the inferred traits (for example, skin_condition_type=DRY, appearance_color_category=SPRING) and writes these codes along with confidence scores into the existing database record for the session. The server thereby creates a persistent mapping from the session identifier to the user characteristic information.

Input: The raw classification results (trait labels and scores) generated in Step 6.

Output: A normalized trait record stored in the database, linked to the session identifier and accessible for downstream processing.

### Step 8:

The server normalizes the situation information.

The server retrieves the situation text from the database record and applies text normalization, such as converting to a standard character set, lowercasing, removing extra whitespace, and optionally mapping synonyms to canonical terms (for example, mapping “PTA meeting” and “parent-teacher meeting” to a standard phrase). The server may also assign category tags (for example, FORMAL_DAYTIME or EVENING_EVENT) based on keyword detection.

Input: The raw situation text stored with the session.

Output: A normalized situation string and optional situation category tags stored in association with the session.

### Step 9:

The server generates a prompt sentence for the generative AI model.

The server selects a text template based on the availability of user characteristic information and the situation category. The server fills placeholder fields in the template with the standardized skin condition type, appearance color category, and normalized situation text.

The server concatenates the resulting segments into a coherent prompt sentence in natural language.

Input: The normalized trait record and the normalized situation string (and optional category tags).

Output: A prompt sentence string, for example, “The user has dry skin and a Spring personal color. The user is attending a parent-teacher meeting. Based on these traits, propose a full-body outfit coordination in pastel tones and recommend suitable skincare and makeup products that are gentle on dry skin.”

### Step 10:

The server encodes the prompt sentence as input to the generative AI model.

The server applies a tokenizer to split the prompt sentence into tokens and converts each token into a numeric identifier based on a predefined vocabulary. The server then maps the token identifiers to embedding vectors and assembles them into an input tensor representing the prompt sequence.

Input: The prompt sentence string generated in Step 9.

Output: An input tensor of token embeddings representing the prompt sentence, ready for model inference.

### Step 11:

The server executes the generative AI model to obtain product candidate information.

The server feeds the input tensor into a neural-network-based generative AI model, such as a multi-layer Transformer architecture. The server performs forward propagation through the model, including matrix multiplications in attention layers and feedforward layers, application of activation functions, and layer normalizations. The model outputs a sequence of tokens or structured text that describe product candidates and coordination details.

Input: The input tensor of token embeddings.

Output: A generated text sequence or semi-structured output containing product candidate information, such as recommended categories, colors, and product attributes.

### Step 12:

The server parses and structures the product candidate information.

The server analyzes the generated output and identifies segments corresponding to individual product candidates and their attributes. The server extracts fields such as product category (for example, “suit,” “blouse,” “moisturizer,” “lipstick”), recommended color characteristics, and constraints (for example, “for dry skin,” “suitable for Spring type,” “for formal event”).

The server transforms this parsed data into a structured internal representation, such as a list of product candidate objects with named attributes.

Input: The generated text or semi-structured output produced by the generative AI model.

Output: A structured product candidate list, each element including category, color attributes, skin compatibility, and situation-related constraints.

### Step 13:

The server matches product candidates to stored product information.

The server queries the product information group stored in the storage device using the structured attributes of each product candidate. The server constructs database queries or search requests that filter products by category, color code, skin_type_applicability, and occasion_tags. The server computes similarity scores between candidate attributes and stored product attributes and ranks candidate products according to these scores.

Input: The structured product candidate list and the product information group stored in the database.

Output: A set of matched product records for each candidate, with associated similarity scores and metadata.

### Step 14:

The server selects recommendation product information.

The server chooses one or more top-ranked products for each product category based on the similarity scores and predefined selection rules (for example, limiting the number of items per category or prioritizing higher confidence matches). The server then aggregates the selected products into a recommendation product information object that includes an outfit coordination and accompanying skincare and cosmetic items.

Input: The matched product records and similarity scores from Step 13.

Output: A recommendation product information object containing selected products and their attributes, structured for presentation to the user.

### Step 15:

The server retrieves visual information associated with the selected products.

The server reads image_reference fields from the selected product records and accesses the corresponding image files or video clips stored in an image repository. The server may optionally resize or compress the images according to the terminal's capabilities or network conditions. The server pairs each selected product with its associated visual information.

Input: The recommendation product information object and product image references retrieved from the database.

Output: A set of visual information items (still image information and/or moving image information) linked to each recommended product.

### Step 16:

The server constructs response information for the terminal.

The server assembles the recommendation product information and the associated visual information into a response payload that includes text fields (for example, product names, descriptions, trait-based reasons for selection) and media fields (for example, image URLs or encoded image data). The server may additionally include identifiers that allow the terminal to group items into coordinated sets (such as outfit bundles).

Input: The structured recommendation product information and linked visual information from Step 15.

Output: A formatted response payload ready to be transmitted to the terminal, containing both textual and visual components.

### Step 17:

The server transmits the response information to the terminal.

The server sends the response payload through the communication interface using a secure transport protocol. The server may set appropriate headers or metadata indicating content type and encoding so that the terminal can correctly interpret the response.

Input: The formatted response payload generated in Step 16.

Output: A network response containing recommendation product information and visual information delivered to the terminal.

### Step 18:

The terminal receives and renders the recommendation.

The terminal parses the received response payload and extracts text and media fields. The terminal downloads any remote images or video resources if referenced by URLs, decodes them, and uses the display device to render product names, descriptions, trait explanations, and associated images in the messaging interface or a dedicated view.

Input: The network response containing formatted recommendation data and visual information.

Output: A displayed set of coordinated products and their images on the terminal screen, visible to the user.

### Step 19:

The user reviews and optionally refines the recommendation.

The user inspects the displayed products, images, and explanations, and decides whether to accept the recommendation, request alternative suggestions, or modify the situation information (for example, changing “formal” to “more casual”). The user may input new text or send additional images, which the terminal will again package and transmit to the server, thereby initiating another cycle of processing starting from Step 1 or Step 2.

Input: The displayed recommendation on the terminal and user interaction (viewing, gestures, or text input).

Output: Optional new user input (additional images or refined situation text) that can serve as fresh input for a subsequent processing cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems that operate on digital commerce platforms typically rely on manually entered user profiles, coarse category preferences, or simple interaction logs such as clicks and purchase histories. Such systems process limited, low-dimensional input data and apply fixed rule sets or basic statistical models to select products. As a result, these systems often fail to accurately capture fine-grained user characteristics, such as detailed appearance attributes, real-world usage contexts, and implicit preferences, thereby limiting the precision and personalization of recommendations.

When image data of a user is available, existing systems frequently treat the image merely as a decorative or auxiliary element, rather than as a primary data source for computing user attributes. In many implementations, image analysis, if present at all, is performed as an isolated function that outputs a rough label (for example, a generic color type or skin type), and the label is then passed to a conventional rules engine. This fragmented processing pipeline introduces several technical problems: (i) the system does not fully utilize the rich information contained in the image, (ii) the recommendation logic is difficult to adapt or scale as new product attributes or user features are introduced, and (iii) the generation of explanatory text for recommendations is typically hard-coded, resulting in repetitive and low-informative user interfaces.

Furthermore, the interaction between image-based analysis and generative artificial intelligence models is often ad hoc and not integrated into a coherent processing sequence. In many architectures, a generative model is only used as a separate content generator that is manually prompted by a human operator. The prompts are not systematically derived from machine-readable feature representations and product attributes. This leads to inefficiencies and inconsistencies: the server must run multiple disjoint components, prompt engineering must be performed manually or by external scripts, and the resulting explanations are not tightly coupled to the actual selection logic performed by the system.

In addition, existing systems tend to handle product search and natural-language generation as independent subsystems, each with its own input format and processing flow. This separation increases latency, requires redundant data transformations, and complicates system maintenance. From a computing standpoint, the system does not exploit the ability of generative AI models to consume structured feature vectors and product attributes in a unified prompt sentence that can drive both ranking refinement and explanation generation. Consequently, the system underutilizes available processing resources, produces recommendations that are less contextually aligned with the user's true characteristics, and fails to provide transparent, machine-generated explanations that improve user trust and interaction quality.

Accordingly, there is a need for a computer-implemented technique that technically improves the way a server processes user image data, extracts numerical features, integrates those features with generative AI models through systematically constructed prompt sentences, performs product selection and ranking based on those AI-derived outputs, and generates coherent, personalized natural-language explanations, all within a unified, machine-executable workflow. Such a technique should reduce manual intervention, improve computational efficiency, and enhance the accuracy and clarity of recommendation output presented on a user terminal.

The specific processing by the specific processing unit 290 of the data processing device 12 in Application Example 1 is realized by the following means.

The present invention provides a server comprising a processor configured to receive, via an input/output device, image data and associated information from a user, the image data including a facial image or a full-body image captured by an information processing terminal operated by the user and transmitted over a communication path; to perform preprocessing on the received image data by using an image processing program to convert the image data to a predetermined resolution and color space, to detect and crop a subject region, and to generate a numerical feature vector including color features and shape features; to input the numerical feature vector and the preprocessed image data into a generative artificial intelligence model including a machine learning model, and to estimate user characteristic information relating to an appearance of the user, the user characteristic information including at least one of skin condition, color tendency, and body shape information; to generate, on the basis of the estimated user characteristic information and usage-purpose information input by the user, a prompt sentence expressed in a natural language, the prompt sentence being configured to instruct selection conditions and explanation conditions for a product or a service; to search, on the basis of the user characteristic information and the prompt sentence, product attribute information stored in a product information storage device, to extract candidate products that match the user characteristic information, and to rank the candidate products according to a relevance degree; to generate, by using a natural language processing generative artificial intelligence model and structured data including the candidate products and the user characteristic information as input, an explanation text including at least one of recommendation reasons, usage methods, and coordination proposals for the candidate products; and to generate output data for transmitting, as visual information, the candidate products and the explanation text to the information processing terminal and to generate presentation information that enables the user to visually confirm the candidate products on a display device of the information processing terminal. This enables a technically integrated and automated processing pipeline in which the server converts rich image data into machine-interpretable feature vectors, systematically constructs prompt sentences that control generative AI behavior, performs product retrieval and ranking in direct coordination with AI-derived user features, and produces coherent, personalized natural-language explanations, thereby improving the computational efficiency, scalability, and accuracy of computer-implemented recommendation processing.

The term “processor” refers to one or more hardware information processing units, such as central processing units or graphics processing units, configured to execute instructions of a program to perform the functions described herein.

The term “input/output device” refers to a hardware component or interface, such as a network interface, communication module, or peripheral interface, that enables transmission and reception of data between the server and an external device, including an information processing terminal.

The term “image data” refers to digital data representing a still image or a sequence of images, including but not limited to a facial image or a full-body image of a user, encoded in a computerized format.

The term “associated information” refers to additional data transmitted together with the image data, including at least user identifiers, usage-purpose information, and metadata describing acquisition conditions or context of the image.

The term “information processing terminal” refers to an electronic device operated by a user, such as a portable terminal, a stationary terminal, or any computing apparatus capable of capturing an image and communicating with a server over a communication path.

The term “communication path” refers to a wired or wireless communication medium and associated protocols that enable data transfer between the information processing terminal and the server.

The term “image processing program” refers to a software module executed by the processor that performs operations on image data, including at least resolution conversion, color space conversion, region detection, and cropping.

The term “predetermined resolution” refers to a fixed or configurable size of an image expressed in pixel dimensions that is specified in advance to meet processing requirements of subsequent analysis or modeling.

The term “color space” refers to a coordinate system or model used to represent colors in digital form, such as an RGB space, a hue-saturation-value space, or another multi-dimensional color representation.

The term “subject region” refers to a portion of the image data that includes at least a part of the user's body or face and is extracted from the overall image for analysis of the user's appearance.

The term “numerical feature vector” refers to an ordered set of numerical values derived from image data, representing quantitative characteristics such as color features, shape features, or other measurable attributes.

The term “color features” refers to numerical measures that describe the distribution, intensity, or composition of colors in a subject region, including histogram values, average color values, or other color-related metrics.

The term “shape features” refers to numerical measures that describe geometric or morphological aspects of a subject region, including outline properties, proportions, or other spatial characteristics.

The term “generative artificial intelligence model” refers to a machine learning model or a set of models configured to generate or infer data, including at least textual data or latent representations, from input features or prompts, and that has been trained using example data.

The term “machine learning model” refers to a computational model constructed by training on data to learn parameters or structures that allow inference, classification, regression, or transformation of input data without being explicitly programmed for all possible inputs.

The term “user characteristic information” refers to information estimated from the image data and feature vectors that represents attributes of the user, including at least skin condition, color tendency, and body shape information.

The term “skin condition” refers to characteristics of the user's skin derived from image data, such as dryness, oiliness, sensitivity, or other dermatological attributes.

The term “color tendency” refers to a classification or numerical description of dominant color properties associated with the user's appearance, including categories representing tonal groups or personal color types.

The term “body shape information” refers to information describing proportions, contours, or silhouettes of the user's body, as inferred from the subject region of the image data.

The term “usage-purpose information” refers to information indicating an intended use or scenario specified by the user, such as an event type, desired style, or functional requirement, which is used to tailor recommendation processing.

The term “prompt sentence” refers to a text expressed in a natural language that is constructed based on user characteristic information and usage-purpose information and that instructs conditions for selecting and explaining products or services when input to a generative artificial intelligence model.

The term “selection conditions” refers to constraints or criteria derived from user characteristic information and usage-purpose information that define which products or services are to be considered suitable for recommendation.

The term “explanation conditions” refers to requirements or guidelines specifying how recommended products or services should be described or justified in generated natural-language text.

The term “product attribute information” refers to structured data describing properties of items stored in a product information storage device, including at least category, usage attributes, color attributes, and suitability attributes.

The term “product information storage device” refers to a storage subsystem, such as a database system or memory device, that stores product attribute information in a machine-readable format.

The term “candidate products” refers to products extracted from product attribute information on the basis of user characteristic information and selection conditions and considered for presentation to the user.

The term “relevance degree” refers to a measure or score indicating how well a candidate product matches user characteristic information, usage-purpose information, or conditions specified in a prompt sentence.

The term “structured data” refers to data organized in a defined format, such as records, lists, or key-value mappings, representing candidate products, user characteristic information, or related attributes in a machine-readable structure.

The term “natural language processing generative artificial intelligence model” refers to a generative artificial intelligence model specifically configured to process and generate text in a human language based on input text and structured data.

The term “explanation text” refers to a body of natural-language text generated by a generative artificial intelligence model that includes at least recommendation reasons, usage methods, or coordination proposals for candidate products.

The term “recommendation reasons” refers to statements in the explanation text that specify why a candidate product is suitable for the user in view of user characteristic information and usage-purpose information.

The term “usage methods” refers to instructions or suggestions in the explanation text that describe how a candidate product should be applied, worn, or used by the user.

The term “coordination proposals” refers to suggestions in the explanation text that describe how multiple items may be combined or styled together to form a coherent appearance or usage set.

The term “output data” refers to data generated by the processor that encodes visual information and associated text for transmission to an information processing terminal for display.

The term “visual information” refers to information that can be presented on a display device, including at least product images, textual descriptions, and layout data for rendering user interfaces.

The term “presentation information” refers to organized output data that associates candidate products and explanation text in a form suitable for rendering on a display device so that a user can visually confirm recommended products.

The term “display device” refers to a hardware output component of an information processing terminal, such as a screen or monitor, configured to visually present information to a user.

In the following embodiments, a server, a terminal, and a user cooperate to implement the invention. The same structural elements may be implemented with different hardware and software in alternative embodiments.

A server includes at least one processor, a memory, a storage device, and a network interface. The processor may be a general-purpose central processing unit and/or a graphics processing unit. The memory may be a volatile memory that stores program instructions and intermediate data. The storage device may be a non-volatile storage device, such as a disk device or a solid-state storage. The network interface may be a wired or wireless communication interface that supports communication over a packet-switched network.

A terminal includes at least one processor, a memory, a display device, an image-capturing device, a user input device, a storage device, and a communication interface. The image-capturing device may be a digital camera module integrated into a handheld device or another information processing device. The user input device may be a touch panel, a keyboard, or physical buttons.

A user operates the terminal to install and start an application program. The application program may be implemented as a native mobile application, a web application executed in a browser, or another executable program. The terminal executes the application program by using the processor and the memory.

A server stores, in the storage device, program modules including an image preprocessing module, a feature extraction module, a generative AI inference module, a prompt generation module, a product retrieval module, a ranking module, an explanation generation module, and a response formatting module. The server stores, in the storage device, one or more trained generative AI models implemented using a machine learning framework, such as a deep learning framework. The server stores, in a product information storage device, product attribute information in a structured format, such as relational records or key-value pairs.

A server uses, as the image preprocessing module, a software library for image processing, such as an open-source image processing library including functions for color-space conversion, resizing, and region detection. The server executes, on the processor, functions that convert image data from an input color space into another color space, such as a hue-saturation-value space or a luminance-chrominance space. The server resizes input images to a fixed width and height, such as 224×224 or 256×256 pixels, so that subsequent neural network models receive inputs of a consistent tensor shape. The server detects a subject region that includes a face or a body, by using a pre-trained detection model, such as a convolutional neural network trained on bounding box annotations. The server crops this subject region and discards irrelevant background pixels. This cropping reduces the input size and noise, thereby lowering computational load and improving feature concentration.

A server uses, as the feature extraction module, functions provided by the image processing library and numerical computation routines. The server calculates, from the cropped subject region, color histograms in a chosen color space. The server normalizes the histograms to produce a probability distribution over color bins. The server computes additional numerical features, such as mean and variance of luminance and chrominance channels, and geometric ratios derived from landmark positions on a face or body. The server assembles these values into a numerical feature vector with a fixed length, such as 128 or 256 dimensions. The server stores the feature vector as a tensor in memory.

A server uses, as the generative AI inference module, a generative AI model implemented as a multi-layer neural network. In one embodiment, the server uses an encoder-decoder architecture, where an encoder network receives the image tensor and the feature vector as inputs, and a decoder network outputs a latent representation and a classification output. The encoder network may include multiple convolutional layers, batch normalization layers, and non-linear activation functions, such as rectified linear units. The decoder network may include fully connected layers that output probability distributions over discrete labels, such as skin type categories and color tendency categories.

A server trains the generative AI model in advance, by using training data that includes labeled images and associated user characteristic information. The server uses, during training, a loss function that combines a classification loss, such as cross-entropy loss, with a reconstruction or regularization term, such as mean squared error or a Kullback-Leibler divergence term. The server updates network weights by using an optimization algorithm, such as stochastic gradient descent or Adam, and adjusts learning rate and other hyperparameters based on validation performance. The server may perform data augmentation during training, such as random cropping, rotation, color jittering, and scaling, in order to improve robustness of the model and reduce overfitting.

A server, during inference, loads the trained weights into memory and executes the generative AI model on the feature vector and preprocessed image tensor. The server obtains, at an output layer, a set of probabilities over skin condition categories and personal color categories. The server selects, for each category type, a label with maximum probability as user characteristic information, and may also retain the probability values as confidence scores. Because the model directly consumes pixel-level information and derived features, the server avoids relying on manually crafted rules and instead uses a learned mapping from high-dimensional input data to characteristic information. This mapping cannot be performed reliably by human operators in real time, and the use of the neural network model improves classification accuracy and consistency across diverse imaging conditions.

A server uses, as the prompt generation module, a program that constructs a prompt sentence in natural language. The server receives, as inputs, the estimated user characteristic information and usage-purpose information supplied by the user through the terminal. The server inserts these values into a predefined template or combines them by using learned patterns. For example, the server may generate a prompt sentence such as:

“The user in this image has oily skin and an autumn personal color. Suggest three appropriate skincare and makeup products with brief explanations.”

or

“The user in this full-body image is preparing for a parent-teacher meeting. Consider the user's personal color and body shape, and generate a formal yet approachable outfit recommendation with specific color and item suggestions.”

The server constructs the prompt sentence in a deterministic manner based on machine-readable data structures. This construction provides a reproducible mapping from numerical features to prompt text, which facilitates consistent behavior of downstream generative AI models and reduces the need for manual prompt engineering.

A server uses, as the product retrieval module, a program that accesses a product information storage device. The product information storage device stores, for each product, a record including attributes such as category, color attributes, material attributes, suitability attributes for skin types or color tendencies, and usage-scene attributes. The server converts the user characteristic information and usage-purpose information into query conditions. For example, the server may map “oily skin” to a boolean or categorical field “suitable_for_oily_skin,” and may map “autumn personal color” to a field “recommended_color_group.” The server executes a query that filters products whose attribute values satisfy these conditions. The server thereby reduces the candidate set from a large product database to a smaller subset that is structurally consistent with the user's features.

A server uses, as the ranking module, a program that computes a relevance degree for each candidate product. In one embodiment, the server defines a feature representation for each product, such as a vector encoding color palette, finish type, skin compatibility, or style tags.

The server computes a similarity or compatibility score between the user characteristic vector and each product vector, for example by using cosine similarity or a learned scoring function. In a more advanced embodiment, the server uses a second neural network that receives, as inputs, concatenated user and product feature vectors, and outputs a scalar relevance score.

The server trains this network with supervised learning on historical interaction data, such as past user selections, to minimize a ranking loss, such as a pairwise ranking loss or listwise loss. The server sorts the candidate products by relevance scores in descending order. A server uses, as the explanation generation module, a natural-language processing generative AI model. The model may be a transformer-based sequence-to-sequence network pre-trained on large text corpora and optionally fine-tuned on domain-specific recommendation texts. The server prepares structured data that includes, for each candidate product, its attributes and the user characteristic information. The server then forms an input text by appending this structured data to the previously generated prompt sentence. For example, the server may generate an input such as:

“Given the following user features and products, generate personalized recommendation messages.

User features: skin type=oily, personal color=autumn.

Product A: mattifying moisturizer, suitable for oily skin, warm beige tone.

Product B: lightweight foundation, oil-free, warm neutral tone.

Please explain why each product is suitable.”

The server inputs this text to the generative AI model. The model, by using attention mechanisms and learned language patterns, generates explanation text that links specific user features to specific product attributes. Because the model receives structured information assembled by the server, the resulting explanation text more accurately reflects the actual selection criteria used in product ranking and reduces contradictions between explanation and underlying data.

A server generates, as explanation text, sentences that include recommendation reasons, usage methods, and coordination proposals. For example, the explanation text may state that a particular foundation controls shine for oily skin, or that certain clothing colors harmonize with an autumn personal color in a formal environment. The server associates each explanation text with a corresponding product identifier in a data structure stored in memory or storage.

A server uses, as the response formatting module, a program that creates output data for the terminal. The server organizes, for each candidate product, product identifiers, names, prices, image references, and the associated explanation text into a structured response, such as a JavaScript Object Notation object or another application-level structure. The server formats the data to minimize payload size by omitting unnecessary fields and by compressing image references, thereby reducing communication load over the network. This reduction in data size improves response time and reduces bandwidth usage.

A terminal receives the response and parses the structured data by using a parsing library.

The terminal constructs a user interface that displays product images, textual explanations, and controls for user interaction. The terminal renders these elements on the display device.

The terminal may cache results to avoid redundant network requests when the user navigates between screens.

A user views the displayed recommendations and may select, on the terminal, items for further inspection or for purchase. The user may request additional recommendations for different purposes, in which case the terminal transmits new usage-purpose information and, optionally, new images to the server.

In one embodiment, the server executes the generative AI inference module on a separate hardware accelerator, such as a dedicated inference server with a graphics processing unit.

The server splits computation between the main processor and the accelerator, so that image preprocessing and database access are performed on the main processor, while neural network inference is performed on the accelerator. This division improves throughput by reducing contention for computational resources and allows the system to handle multiple concurrent requests without significant degradation in latency.

In another embodiment, the server compresses intermediate feature vectors before storing them in memory or transmitting them between processes, by using dimensionality reduction techniques, such as principal component analysis or autoencoder-based compression. The server then reconstructs approximate feature vectors when needed. This approach reduces memory footprint and network traffic in distributed deployments, while maintaining sufficient information for accurate recommendations.

In another embodiment, the server stores user characteristic information in a profile store associated with user identifiers. The server updates the profile store when new images and contextual information are processed. The server uses profile caching so that, for subsequent requests without new images, the server can skip image preprocessing and generative model inference and proceed directly to prompt generation and product retrieval. This design reduces redundant computation and improves processing speed for repeat users.

The system provides technical effects beyond mere automation of human decision-making.

The server uses specialized neural network architectures, data structures, and prompt generation mechanisms that are optimized for machine execution. By converting rich image data into structured numerical features and then into prompt sentences that control generative

AI behavior, the server reduces the number of separate processing stages and manual interventions that are typically required to combine image analysis with text generation and product selection. The server thereby improves computational efficiency and consistency.

The system also improves accuracy and reduces error in recommendation processing. The neural network models are trained with explicit loss functions that optimize classification of user attributes and relevance of product matches. These training procedures reduce misclassification rates and mismatches compared with simple rule-based systems or manual judgment. The use of high-dimensional feature vectors and learned similarity measures allows the server to detect subtle patterns and correlations in data, which human operators cannot reliably capture at scale.

The system additionally improves data management. The server maintains structured representations of user characteristics, products, and generative prompts, which simplifies logging, monitoring, and debugging of recommendation behavior. When errors or discrepancies occur, the server can trace back from a particular explanation text to the exact feature vectors and prompt sentences that produced it. This transparency enables controlled maintenance and refinement of the models and algorithms.

The system further reduces communication load between the terminal and the server. The terminal transmits only essential image data and minimal metadata, while the server performs computationally intensive operations locally. The server also optimizes response payloads, as described above. This arrangement makes effective use of network resources and supports operation over mobile networks with limited bandwidth.

Alternative embodiments may modify specific model architectures, feature sets, or data formats. For example, the generative AI model for explanation generation may be replaced with a different sequence model, such as a recurrent neural network with attention mechanisms, or a hybrid model that combines rule-based templates with generated text. The feature extraction module may add or remove feature types, such as frequency-domain features or three-dimensional pose estimates. The product retrieval module may use different database technologies, such as key-value stores or graph databases, as long as product attribute information remains accessible and structured.

In all embodiments, the server, the terminal, and the user cooperate in a technical workflow in which image-capture hardware, communication infrastructure, specialized image processing software, machine learning models, and structured data processing modules interact to achieve higher-speed, higher-accuracy, and more transparent recommendation processing than systems that rely solely on manual input or simple rules.

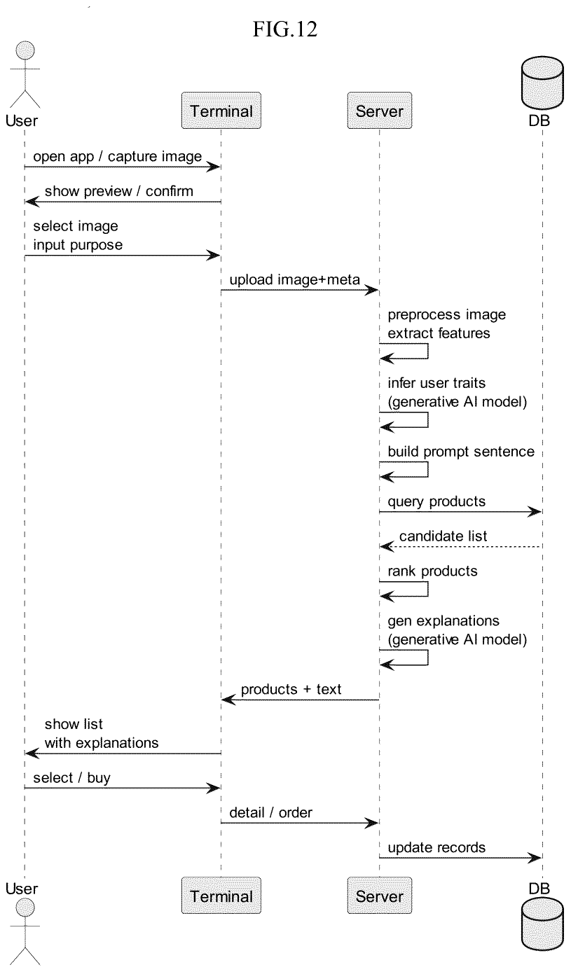

The following describes the processing flow using FIG. 12.

### Step 1:

The user operates the terminal to launch an application for product recommendation.

The terminal activates a camera module and displays a live preview on the display device.

The user uses the terminal to capture at least one facial image or full-body image and confirms the captured image.

Input: raw sensor data from the camera hardware.

The terminal converts the raw sensor data into digital image data in a standard format, stores the image data in local storage, and assigns a file path identifier.

Output: stored image file and corresponding file path in the terminal.

### Step 2:

The terminal displays an interface that allows the user to select the stored image and to input usage-purpose information, such as “skincare recommendation” or “parent-teacher meeting outfit.”

The user uses the input device of the terminal to select the image and to enter the usage-purpose information.

Input: stored image file, file path, and textual usage-purpose input from the user.

The terminal constructs a data structure that includes the image file, a user identifier, and the usage-purpose information.

Output: upload request data containing the image file and metadata.

### Step 3:

The terminal establishes a secure communication connection with the server by using a communication protocol.

The terminal embeds the upload request data into a message body and transmits the message to the server over a communication path.

Input: upload request data containing the image file, user identifier, and usage-purpose information.

The terminal performs data serialization, sets appropriate headers, and sends the serialized data.

Output: transmitted network packet stream toward the server.

### Step 4:

The server receives the network packet stream through a network interface and reconstructs the upload request data.

The server validates authentication information to identify the user and checks integrity of the received data.

Input: serialized network packets containing the image file and associated metadata.

The server deserializes the packets to recover the image file, user identifier, and usage-purpose information, and stores the image file into a storage device while recording a storage location and metadata in a database.

Output: persistent image record and associated metadata stored on the server.

### Step 5:

The server loads the stored image file from the storage device into memory.

The server invokes an image processing program to decode the image file into an internal matrix representation.

Input: encoded image file and its storage location.

The server converts the image into a matrix of pixel values, transforms the color space (for example, from RGB to HSV), and resizes the matrix to a predetermined resolution required by subsequent models.

Output: preprocessed image tensor with normalized size and color representation.

### Step 6:

The server executes a subject-region detection algorithm on the preprocessed image tensor.

The server uses a trained detection model to locate a face region or a full-body region within the image.

Input: preprocessed image tensor.

The server computes feature maps, generates bounding boxes around candidate subject regions, selects a bounding box with the highest confidence score, and crops the corresponding region to form a refined subject-region tensor.

Output: cropped subject-region tensor focused on the user's appearance.

### Step 7:

The server calculates numerical features from the subject-region tensor by using image analysis functions.

The server computes color histograms, statistical moments of color channels, and geometric ratios from detected landmarks.

Input: subject-region tensor representing the user's face or body.

The server partitions the subject region into spatial bins, counts pixel occurrences in each color bin, normalizes these counts, and calculates additional metrics such as aspect ratios and contour descriptors, then concatenates all metrics into a fixed-length numerical feature vector.

Output: numerical feature vector encoding color features and shape features.

### Step 8:

The server inputs the subject-region tensor and the numerical feature vector into a generative AI model implemented as a neural network.

The server executes the neural network forward pass to infer user characteristic information.

Input: preprocessed image tensor and numerical feature vector.

The server multiplies the input tensors by learned weight matrices, applies non-linear activation functions across multiple layers, computes intermediate feature representations, and outputs probability distributions over categories such as skin condition and color tendency; then the server selects the most probable categories and records them as user characteristic information with associated confidence values.

Output: user characteristic information including at least skin condition, color tendency, and optionally body shape information.

### Step 9:

The server combines the user characteristic information with the usage-purpose information received from the terminal.

The server constructs a prompt sentence in natural language based on these combined pieces of information.

Input: user characteristic information and textual usage-purpose information.

The server fills predefined text templates or assembles phrases by inserting the characteristic labels and usage-purpose terms into sentence patterns, thereby generating a prompt sentence such as “The user in this image has oily skin and an autumn personal color. Suggest three appropriate skincare and makeup products with brief explanations.”

Output: prompt sentence expressed in natural language.

### Step 10:

The server interprets the user characteristic information and the prompt sentence to derive product selection conditions.

The server maps characteristic labels to product attribute filters defined in a product information schema.

Input: user characteristic information and prompt sentence.

The server converts each characteristic, such as “oily skin” or “autumn personal color,” into specific database conditions, such as flags or categorical fields, and constructs a query object that represents a set of constraints for product retrieval.

Output: structured query conditions for accessing product attribute information.

### Step 11:

The server executes a query against the product information storage device by using the structured query conditions.

The server retrieves a subset of product records that satisfy the selection conditions.

Input: query conditions referencing product attributes such as category, suitability, and color group.

The server performs index lookups, applies filters to records, and compiles a list of candidate products along with their attribute fields.

Output: candidate product list with associated attribute information.

### Step 12:

The server computes a relevance degree for each candidate product relative to the user characteristic information.

The server uses a scoring algorithm or a learned ranking model to evaluate compatibility.

Input: user characteristic information and candidate product attribute vectors.

The server calculates similarity scores by numerical operations such as vector dot products, distance measures, or outputs from a dedicated ranking neural network, and assigns a scalar relevance score to each candidate; then the server sorts the candidate products in descending order of relevance.

Output: ranked candidate product list with relevance scores.

### Step 13:

The server prepares structured data that summarizes the user characteristic information and the ranked candidate products.

The server transforms product records into a format suitable for inclusion in a natural-language input.

Input: user characteristic information and ranked candidate product list.

The server extracts key fields, such as product names, categories, and suitability attributes, and organizes them in an ordered structure aligned with the rank positions.

Output: structured data set describing user features and candidate product attributes.

### Step 14:

The server constructs an extended prompt sentence for a natural-language processing generative AI model by combining the previously generated prompt sentence with the structured data.

The server embeds the structured product attributes and user features into the prompt text.

Input: original prompt sentence and structured data describing products and user characteristics.

The server concatenates descriptions of user features and product attributes to the original prompt, forms a detailed instruction text such as “Given the following user features and products, generate personalized recommendation messages,” and appends itemized product descriptions.

Output: extended prompt sentence for the generative AI model.

### Step 15:

The server inputs the extended prompt sentence into the natural-language processing generative AI model.

The server executes text generation to produce explanation text for each candidate product.

Input: extended prompt sentence containing user features and product attributes.

The server tokenizes the input text, converts tokens into embeddings, processes them through layers of the language model to compute context-aware representations, and sequentially generates output tokens that form explanation sentences, which are then detokenized into natural-language strings.

Output: explanation text including recommendation reasons, usage methods, and coordination proposals for the candidate products.

### Step 16:

The server associates the generated explanation text with the corresponding candidate products in a response structure.

The server prepares output data that includes product identifiers, attributes, and explanation text.

Input: ranked candidate product list and generated explanation text for each product.

The server pairs each explanation sentence with a product entry, constructs an array or list of product objects, and embeds the associated explanation texts into each object.

Output: structured response data suitable for transmission to the terminal.

### Step 17:

The server formats the structured response data into a message for transmission and optimizes it for communication efficiency.

The server serializes the data into a compact representation and attaches necessary protocol headers.

Input: structured response data comprising product objects and explanation texts.

The server encodes the data, optionally compresses it, and constructs a response message that conforms to the communication protocol used with the terminal.

Output: serialized response message ready to be sent to the terminal.

### Step 18:

The terminal receives the serialized response message from the server through the communication interface.

The terminal reconstructs the structured response data by deserializing the message.

Input: serialized response message containing product and explanation data.

The terminal verifies message integrity, decodes the payload, and restores the array or list of product objects with associated explanation texts.

Output: in-memory representation of recommended products and explanations on the terminal.

### Step 19:

The terminal renders a user interface on the display device based on the in-memory representation.

The terminal generates graphical components such as product cards, text fields, and interactive buttons.

Input: recommended products and explanation texts stored in memory.

The terminal iterates over the product objects, creates visual elements for each product image and explanation text, lays out the elements according to a predefined design, and outputs the result to the display hardware so that the user can visually inspect the recommendations.

Output: rendered screen showing recommended products and their explanation texts.

### Step 20:

The user reviews the displayed recommendations and performs interaction on the terminal.

The user may select a product, request more details, or initiate a purchase.

Input: displayed user interface with interactive components.

The user triggers events by touching or clicking elements; the terminal captures these events, updates the interface, and may send follow-up requests to the server to retrieve additional information or to process transactional operations.

Output: user interaction events and, optionally, additional requests sent to the server for further processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recommendation systems typically rely on manually entered profile attributes, simple rule sets, or coarse-grained behavioral logs to generate product or styling suggestions. Such systems generally treat user characteristics and usage situations as static or weakly structured data, and therefore generate recommendations that are generic, poorly personalized, and often irrelevant to a user's actual appearance and current context. In particular, these systems do not effectively exploit rich image information capturing a user's physical features, such as skin tone or overall appearance, in combination with free-form natural language queries that describe the user's situational needs. From a computing technology standpoint, existing systems suffer from several technical limitations. First, the processing pipeline for image analysis, natural language understanding, and recommendation generation is often fragmented, requiring separate subsystems that are loosely integrated and that exchange only simplified, lossy representations. This fragmentation leads to increased processing latency, inefficient resource utilization, and degraded end-to-end accuracy. Second, conventional systems do not provide a robust mechanism for constructing high-quality input prompts for generative artificial intelligence models based on tightly coupled multimodal context, including both image-derived attributes and text-derived situation information. As a result, the underlying generative models operate on incomplete or noisy context, which reduces the precision and consistency of the generated outputs. Third, existing architectures rarely incorporate a structured feedback loop that maps the outputs of the generative models back to concrete recommendation objects, such as candidate merchandise information and attire information, in a way that is systematically aligned with the extracted user attributes and situational constraints.

Accordingly, there is a need for an improved computer-implemented system that integrates image analysis, natural language processing, and generative artificial intelligence models in a unified processing pipeline. Such a system should automatically extract detailed attribute information from user images, interpret unstructured prompt sentences to obtain situation information and request content information, and construct optimized prompt sentences for generative models. The system should also transform the raw outputs of the generative models into structured recommendation information, including candidate merchandise information and attire information, and deliver this information efficiently to an information processing terminal. By addressing these issues at the system and algorithmic levels, the invention aims to improve the technical functioning of computer-based recommendation engines, enhance the quality and relevance of generated proposals, and reduce computation redundancy and latency in the overall processing flow.

The specific processing by the specific processing unit 290 of the data processing device 12 in Example 2 is realized by the following means.

The present invention provides a server comprising a processor configured to receive, via a communication network, request information including image information and a prompt sentence from an information processing terminal operated by a user, to perform image analysis processing on the received image information to detect a body region included in the image information, to calculate color information and brightness information based on pixel information corresponding to the body region, and to identify attribute information including user characteristic information based on the color information and the brightness information, to perform natural language processing on the prompt sentence to extract situation information and request content information from the prompt sentence, to generate, based on context information including the attribute information, the situation information, and the request content information, a prompt sentence to be input to a generative artificial intelligence model, to input the prompt sentence to the generative artificial intelligence model and cause the generative artificial intelligence model to generate response information including proposal information corresponding to the context information, to generate recommendation information including candidate merchandise information and attire information based on the proposal information included in the response information, and to transmit the recommendation information to the information processing terminal so that the candidate merchandise information and the attire information are displayed on the information processing terminal. This enables an integrated computer-implemented pipeline in which multimodal user context is automatically extracted and fused, in which a generative artificial intelligence model operates on a precisely constructed prompt reflecting both image-derived and language-derived information, and in which the resulting proposal information is deterministically mapped to structured recommendation information, thereby improving the accuracy, personalization, and computational efficiency of recommendation processing in the server.

The term “system” refers to an arrangement including at least one hardware device and at least one software component that cooperatively execute processing to provide functions described in the claims.

The term “processor” refers to a hardware computation unit, such as a central processing unit or a graphics processing unit, that executes instructions to perform the processing steps described in the claims.

The term “communication network” refers to a wired or wireless data communication infrastructure, such as a local area network, a wide area network, or the Internet, through which data is transmitted between the server and the information processing terminal.

The term “information processing terminal” refers to an electronic device operated by a user, such as a mobile device, a tablet device, or a personal computer, that is capable of transmitting and receiving data via the communication network and displaying information to the user.

The term “request information” refers to information transmitted from the information processing terminal to the server, the information including at least image information and a prompt sentence.

The term “image information” refers to digital data representing a still image that includes at least a part of a user's body region, the digital data being stored in a predetermined format such as a raster image format.

The term “prompt sentence” refers to a natural language text string input by the user that expresses at least a request for a recommendation and may include situation information and preference information.

The term “image analysis processing” refers to computational processing performed on image information to derive numerical or symbolic data, the processing including at least detection of a body region and calculation of color information and brightness information.

The term “body region” refers to a region in the image information that corresponds to at least a part of a human body, including, for example, a face region, a torso region, or a full-body region.

The term “pixel information” refers to numerical values representing at least color components and brightness components of individual picture elements constituting the image

The term “color information” refers to numerical values or statistical values derived from the pixel information that represent chromatic components of the body region, expressed in a color space such as an RGB color space, a hue-saturation-value color space, or a luminance-chrominance color space.

The term “brightness information” refers to numerical values or statistical values derived from the pixel information that represent luminance or intensity components of the body region.

The term “attribute information” refers to structured data that represents one or more characteristics associated with the user, the attribute information including at least user characteristic information derived from the image information.

The term “user characteristic information” refers to information representing physical attributes of the user inferred from the image information, the information including, for example, skin type, personal color category, or body-related attributes.

The term “natural language processing” refers to computational processing applied to a text string, including the prompt sentence, to analyze linguistic structure and semantics and to extract information such as situation information and request content information.

The term “situation information” refers to information indicating a contextual condition in which the user intends to use a recommendation, the information including, for example, an event type, a formality level, a time, or a place.

The term “request content information” refers to information indicating a content of a user's request extracted from the prompt sentence, the information including, for example, a requested type of product, a requested style of attire, or a requested category of advice.

The term “context information” refers to a collection of data including at least the attribute information, the situation information, and the request content information, which are used together as input conditions for the generative artificial intelligence model.

The term “generative artificial intelligence model” refers to a trained computational model that receives an input including a prompt sentence and generates new output data, such as natural language text, based on learned patterns in training data.

The term “prompt sentence to be input to a generative artificial intelligence model” refers to a text string constructed by the processor based on the context information and formatted as an instruction or query suitable for input to the generative artificial intelligence model.

The term “response information” refers to information output by the generative artificial intelligence model in response to the prompt sentence, the information including at least proposal information.

The term “proposal information” refers to content generated by the generative artificial intelligence model that describes recommendations, examples, or guidelines, the content being derived from the context information.

The term “recommendation information” refers to structured information generated by the processor based on the proposal information, the information including at least candidate merchandise information and attire information.

The term “candidate merchandise information” refers to information representing one or more items of merchandise proposed to the user, the information including, for example, a category, a type, or an attribute of each item.

The term “attire information” refers to information representing one or more combinations of clothing and accessories proposed to the user, the information including, for example, types, colors, and arrangements of garment items.

The term “storage device” refers to a hardware component configured to store data in a non-transitory manner, such as a semiconductor memory device, a magnetic storage device, or an optical storage device.

The term “group of merchandise information” refers to a collection of merchandise-related records stored in the storage device, each record including at least an identifier and attribute data describing a merchandise item.

The term “visual information” refers to data representing visual content generated by the processor, including, for example, image data or layout data that visually expresses at least part of the candidate merchandise information or the attire information.

The term “display device of the information processing terminal” refers to a hardware component of the information processing terminal, such as a liquid crystal display or an organic light-emitting diode display, that outputs visual information to the user.

In one embodiment, a server, a terminal, and a user cooperate to implement the invention. The server includes at least one processor, a memory, a non-transitory storage device, and a network interface. The terminal includes a processor, a memory, a display device, and a communication interface. The user operates the terminal to provide image information and a prompt sentence, and to receive recommendation information including candidate merchandise information and attire information.

The server executes a program stored in the memory to implement image analysis processing, natural language processing, prompt construction for a generative AI model, execution of the generative AI model, and post-processing of outputs from the generative AI model. The server executes these processes in an integrated pipeline using specific data structures and algorithms to improve the accuracy and efficiency of recommendation generation.

The terminal operates as an information processing terminal. The terminal executes a messaging application to display a chat interface and to transmit and receive messages via a communication network. The terminal transmits image information and a prompt sentence to the server and displays recommendation information received from the server. The terminal provides a user interface through which the user selects images, inputs text, and views results. The user operates the terminal to launch the messaging application and to select one or more images stored in a local storage device of the terminal. The user selects, for example, a face photo or a full-body photo that clearly shows at least part of the user's body region. The user also inputs a prompt sentence expressing a request or situation, such as “I want to know what outfit is suitable for a parents' meeting at my child's elementary school,” “Please suggest a casual date outfit for a winter-type male,” or “Recommend makeup and skincare for my dry skin and office work.”

The server uses a network interface to receive, via the communication network, request information including the image information and the prompt sentence from the terminal. The server stores the received request information in a non-transitory storage device, such as a magnetic disk device, a semiconductor memory device, or a networked storage device. The server associates the stored request information with a user identifier or a session identifier and manages the data in a structured manner, for example using records in a relational database.

The server uses an image analysis module implemented by software such as an image processing library running on the processor, for example a library that provides functions equivalent to general-purpose computer vision libraries. The server reads the stored image information into main memory and converts the image into a standardized format, such as a three-channel color image represented in a predetermined color space. The server then detects a body region in the image. The server can use a trained convolutional neural network (CNN) for human body and face detection. The CNN can have multiple convolutional layers, pooling layers, and fully connected layers trained on labeled human pose datasets. The server executes the CNN on a graphics processing unit configured as a coprocessor to accelerate matrix multiplication and convolution operations.

The server identifies a bounding box for a face region and optionally a bounding box for an upper-body region or a full-body region. The server then extracts pixel information corresponding to the detected body region. The server converts the pixel information from the original color space to a color space better suited for skin analysis, such as a hue-saturation-value space or a luminance-chrominance space. The server computes, for the pixels in the body region, statistical features including mean hue, hue variance, mean saturation, brightness histogram, and skin texture descriptors.

The server applies a classification model to the computed features to derive user characteristic information. The server may use a multilayer perceptron or a gradient-boosted decision tree model trained on labeled imagery indicating skin type and personal color categories. The server computes an output vector representing probabilities for each skin type class (e.g., dry, oily, combination, sensitive) and each personal color class (e.g., spring, summer, autumn, winter). The server selects the class with the highest probability as the estimated user characteristic. The server stores the result as attribute information in a structured data record, for example with fields indicating skin type, personal color, and additional body-related attributes such as approximate silhouette or body proportion derived from pose estimation.

The server executes a natural language processing module on the prompt sentence provided by the user. The server may use a tokenization component, a part-of-speech tagger, and an entity recognition component implemented using a transformer-based language model. The server processes the prompt sentence to extract situation information such as event type (e.g., parents' meeting, job interview, casual date), formality level (e.g., casual, semi-formal, formal), and place (e.g., school, office, cafe). The server also extracts request content information, such as a requested type of recommendation (“outfit,” “skincare,” “makeup,” “grooming”) and optional constraints (e.g., “I prefer skirts instead of pants,” “I want a more casual version,” “I do not use fragrance”).

The server combines the attribute information derived from the image analysis and the situation information and request content information derived from the prompt sentence into context information. The server represents the context information as a structured internal object, including fields for user characteristics, situation type, event attributes, and requested categories. The server then constructs a dedicated prompt sentence for a generative AI model based on this context information.

The server formulates the prompt sentence for the generative AI model in natural language, so that the generative AI model receives a detailed description of the user and context. The server includes, for example, a description such as: “You are a fashion and beauty stylist. User features: skin type=dry, personal color=summer, gender=female, age=35. Situation: parents' meeting at an elementary school in spring, semi-formal, indoor. Using these features, propose one or two complete outfits (top, bottom or dress, shoes, bag, accessories) and a skincare and makeup routine that match a summer personal color. Explain the color choices and style in detail.” In another example, the server constructs a prompt sentence such as:

“User features: skin type=oily, personal color=winter, gender=male, age=28. Situation: casual date at a cafe in the evening. Generate outfit recommendations including tops, bottoms, shoes, and accessories, and suggest grooming products such as face wash and styling products that suit oily skin and winter coloring. Keep the tone friendly and practical.” The server executes a generative AI model on the processor or on a dedicated accelerator.

The generative AI model may comprise a transformer-based neural network trained for text generation, having multiple self-attention layers, feed-forward layers, and layer normalization operations. The server stores the model parameters, such as weight matrices and bias vectors, in the memory or in a storage device optimized for model serving. The server uses a model execution engine, such as a deep learning framework, to perform batched matrix multiplications and attention computations on a graphics processing unit.

The server inputs the constructed prompt sentence to the generative AI model and receives a text sequence as response information. The server configures decoding parameters such as temperature, top-k, and maximum token length to control diversity and length of the generated proposal information. The server thus ensures that the generated response is detailed enough to be useful, but constrained to avoid irrelevant or excessively long output. The server performs post-processing on the response information to transform unstructured text into structured recommendation information. The server uses pattern matching, regular expressions, and secondary language models to identify segments related to candidate merchandise information and segments related to attire information. The server maps text expressions such as “light-grey tailored jacket” or “cool-toned pink lipstick” to product categories and style attributes stored in a merchandise information database.

The server accesses a storage device that stores a group of merchandise information. The server executes a search module that compares merchandise attributes stored in the database with the proposal information and with the attribute information and situation information.

The server employs non-traditional matching rules that combine color compatibility metrics, skin-type suitability scores, and situation constraints, rather than simple keyword matching. For example, the server computes a similarity score for each merchandise item based on a weighted sum of color distance in a perceptual color space, skin-type compatibility scores derived from empirical data, and situation fit scores derived from usage patterns. The server selects, as candidate merchandise information, items having similarity scores above a threshold or being among top-ranked results.

The server generates recommendation information by combining selected merchandise items with attire combinations described in the proposal information. The server may construct recommended outfits that match body proportions inferred from the image, choosing garment cuts and lengths that are technically known to balance specific silhouettes. The server encodes the recommendation information as a structured record that includes a list of apparel items, cosmetic items, and accessories, each with style attributes and explanatory text derived from the generative AI model.

The server may also generate visual information to be displayed on the terminal. The server can compose layout data that places text descriptions alongside representative images of garment types or generic silhouettes colored according to the recommended personal color palette. The server uses graphics rendering functions to generate such composited images or to specify layout information for rendering on the terminal. By generating visual information in this way, the server reduces the cognitive load on the user and improves understanding of complex styling proposals.

The server transmits the recommendation information and optionally the visual information to the terminal using a communication protocol over the communication network. The terminal receives the recommendation information and displays it on the display device in a structured format, such as sections for “Outfit,” “Skincare,” and “Makeup.” The user views the recommendations and may input additional prompt sentences to refine the request, such as “Please show a more casual version,” “Show a style suitable for colder weather,” or “Change the color scheme to darker tones.” The server processes these additional prompt sentences in the same pipeline, thereby enabling iterative refinement while reusing the previously derived attribute information.

This architecture provides several technical effects. The server avoids fragmented processing by integrating image analysis, natural language processing, and generative AI execution into a single pipeline, using consistent context information and data structures. The server improves processing speed by normalizing image resolutions, using dedicated accelerators for neural network inference, and recycling attribute information across multiple interactions.

The server improves accuracy by extracting high-dimensional feature vectors from images and text, and by constructing detailed prompt sentences that reduce ambiguity for the generative AI model. The server reduces computational redundancy by avoiding repeated feature extraction for the same user unless new image information is provided.

The server improves communication efficiency by transmitting compact representations of images and structured recommendation information instead of large volumes of unstructured text or redundant data. The server handles context locally and sends only necessary display data to the terminal, thereby reducing network load. The server also improves data management by storing attribute information, situation information, and recommendation information in normalized database tables, enabling rapid retrieval and consistency across sessions.

The server uses training procedures that further reinforce the technical nature of the system.

The server can train the image analysis models and the classification models using supervised learning on annotated datasets, with a loss function such as cross-entropy over skin type and personal color labels. The server updates model weights using stochastic gradient descent or adaptive optimization algorithms, with mini-batch processing on a graphics processing unit.

The server may apply data augmentation to the training images, such as random cropping, color jittering, and brightness scaling, to make the models robust to variations in lighting and pose. The server similarly trains the natural language processing components using labeled corpora of prompt sentences and their associated situation labels and request content labels.

The server uses the generative AI model as a specialized component in a larger technical system, not merely as a general-purpose text generator. The server constrains the generative AI model by providing structured, machine-derived context information and by post-processing outputs with rule-based and learned matching schemes. The server thereby achieves improvements in recommendation precision and consistency that cannot be obtained by manually written rules or by human operators performing ad hoc styling.

The described system does not simply automate a human stylist's mental process, because the server relies on numerical feature extraction from images, vector representations of text, and complex similarity computations that are not practically performed by humans at comparable scale and speed. The server uses non-intuitive combinations of multi-dimensional features and technical thresholds to select and rank merchandise items. As a result, the system achieves measurable reductions in error rates of color and style mismatches, as well as reductions in average computation time per recommendation session, relative to conventional systems that rely on separate, loosely coupled modules.

In alternative embodiments, the server can use different neural network architectures for the generative AI model, such as encoder-decoder architectures with attention or mixture-of-experts structures. The server can also vary the method of constructing prompt sentences, for example by including intermediate symbolic labels derived from image analysis, or by inserting style tags that guide the generative model towards conservative, casual, or avantgarde proposals. The server can further adapt the image analysis processing to focus on specific regions such as hair, eyes, or lips, to refine cosmetic recommendations. The terminal can be implemented as any device capable of executing a messaging application and rendering textual and visual information, and the communication network can include various wired and wireless technologies.

By combining these elements, the server, the terminal, and the user cooperate to implement a technically improved recommendation system in which the generative AI model is tightly integrated with domain-specific image analysis and language understanding. This integration leads to enhanced computational efficiency, higher recommendation quality, and improved utilization of hardware resources in the server, and thus constitutes an improvement in computer technology itself.

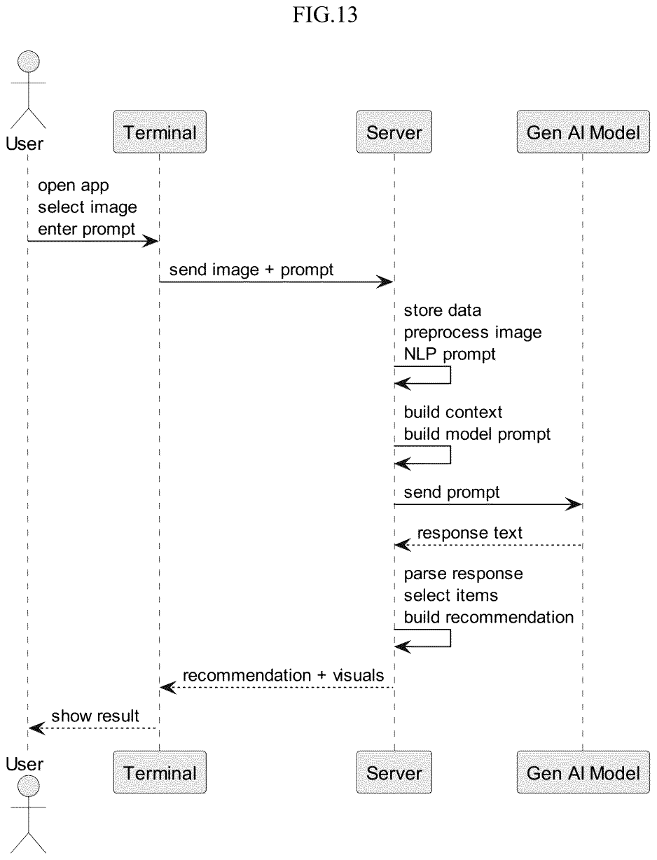

The following describes the processing flow using FIG. 13.

### Step 1:

The user operates the terminal to launch a messaging application and to open a chat screen connected to the server. The input to this step is application configuration data stored in the terminal and a user account identifier. The terminal reads the configuration data from local storage, initializes a communication session with the server over a communication network, and outputs a ready state in which the user can input image information and a prompt sentence.

### Step 2:

The user operates the terminal to select one or more images stored in a local storage device of the terminal. The input to this step is a collection of stored image files and user touch or pointer operations. The terminal reads the selected image file from storage, encodes the file in a predetermined image format, and outputs encoded image information ready for transmission to the server.

### Step 3:

The user operates the terminal to input a prompt sentence into a text input area of the messaging application. The input to this step is user keystrokes or speech converted to text.

The terminal aggregates the characters into a text string, associates the string with the user account identifier, and outputs the prompt sentence as part of request information.

### Step 4:

The terminal packages the encoded image information and the prompt sentence into a message payload and transmits the payload to the server via the communication network. The input to this step is the encoded image information and the prompt sentence generated in Steps 2 and 3. The terminal performs data encapsulation into a protocol format, applies encryption such as transport-level security, and outputs an HTTP or similar request to the server.

### Step 5:

The server receives the request information from the terminal and stores the raw data. The input to this step is the network request containing the image information and the prompt sentence. The server validates headers and payload size, parses the protocol message, writes the image data to a non-transitory storage device, records the prompt sentence in a database, and outputs storage locations and an internal request identifier.

### Step 6:

The server loads the stored image information into main memory and performs preprocessing for image analysis. The input to this step is the file path or storage identifier of the image information. The server uses an image processing library to read pixel data, converts the image to a standard color format, resizes the image to a fixed resolution, normalizes pixel values, and outputs a preprocessed image tensor suitable for further computation.

### Step 7:

The server detects a body region in the preprocessed image and extracts pixel information corresponding to the detected region. The input to this step is the preprocessed image tensor from Step 6. The server runs a trained detection model or pattern classifier, computes bounding boxes for face and body regions, crops the relevant regions from the image, and outputs region-specific image tensors representing at least a face region and optionally a full-body region.

### Step 8:

The server converts the pixel information of the body region to one or more analysis-oriented color spaces and calculates color information and brightness information. The input to this step is the region-specific image tensor from Step 7. The server executes color space transformations, computes per-pixel hue, saturation, and luminance values, aggregates these values into statistical descriptors such as means and histograms, and outputs numerical feature vectors representing color information and brightness information for the body region.

### Step 9:

The server derives attribute information including user characteristic information from the color information and brightness information. The input to this step is the numerical feature vectors generated in Step 8. The server feeds the feature vectors into one or more trained classification models, computes class probabilities for skin types and personal color categories, selects the most probable classes, and outputs attribute information including at least a skin type label and a personal color label.

### Step 10:

The server executes natural language processing on the prompt sentence to extract situation information and request content information. The input to this step is the stored prompt sentence from Step 5. The server tokenizes the text, applies part-of-speech tagging and entity recognition, identifies expressions indicating events, locations, and requested recommendation types, maps these expressions to standardized labels, and outputs structured situation information and request content information.

### Step 11:

The server constructs context information by combining the attribute information, the situation information, and the request content information. The input to this step is the attribute information from Step 9 and the structured information from Step 10. The server merges the data into a unified internal object, assigns fields for user characteristics, event type, formality, and requested categories, and outputs the context information as a structured record used to guide later processing.

### Step 12:

The server generates a detailed prompt sentence for a generative AI model based on the context information. The input to this step is the context information from Step 11. The server composes a natural language description that embeds the user characteristics and situation labels, formats the description into an instruction-style sentence, optionally inserts constraints and style guidelines, and outputs a model-specific prompt sentence such as “You are a fashion and beauty stylist. User features: skin type=dry, personal color=summer, gender=female, age=35. Situation: parents' meeting at an elementary school in spring, semi-formal, indoor. Using these features, propose one or two complete outfits and a skincare and makeup routine.”

### Step 13:

The server inputs the constructed prompt sentence to a generative AI model and obtains response information. The input to this step is the model-specific prompt sentence from Step 12. The server passes the prompt sentence through an application programming interface or a local model execution engine, configures generation parameters such as maximum length and sampling strategy, runs forward passes through the neural network to compute token probabilities, decodes a sequence of tokens into natural language text, and outputs response information including proposal information.

### Step 14:

The server analyzes the response information to extract candidate merchandise descriptions and attire descriptions. The input to this step is the generated text from Step 13. The server splits the text into segments, applies pattern recognition and secondary language analysis to identify phrases corresponding to product categories and clothing combinations, normalizes color and item names, and outputs intermediate proposal data structures containing merchandise attributes and attire attributes.

### Step 15:

The server searches a stored group of merchandise information in a storage device based on the attribute information, the situation information, and the proposal data. The input to this step is the attribute information from Step 9, the situation information from Step 10, and the proposal data from Step 14. The server computes similarity scores between proposal attributes and database records using numerical comparison of color vectors, skin-type compatibility scores, and situation-specific usage tags, filters and ranks the merchandise items, and outputs candidate merchandise information representing selected items.

### Step 16:

The server generates recommendation information that combines the candidate merchandise information with attire information. The input to this step is the candidate merchandise information from Step 15 and the attire attributes from Step 14. The server associates specific merchandise items with roles in the attire combinations, organizes the items into outfit sets and care routines, attaches explanatory text derived from the proposal information, and outputs a structured recommendation record including sections for outfits, skincare, and makeup.

### Step 17:

The server optionally generates visual information representing part of the candidate merchandise information and attire information. The input to this step is the structured recommendation record from Step 16. The server selects representative images or templates, overlays color indicators and labels, composes layout instructions or raster images using a graphics rendering module, and outputs visual information suitable for display on the terminal.

### Step 18:

The server transmits the recommendation information and optionally the visual information to the terminal. The input to this step is the structured recommendation record and, where available, the visual information from Steps 16 and 17. The server formats the data into response messages, encapsulates the messages in a communication protocol, sends the messages through the communication network, and outputs network packets addressed to the terminal.

### Step 19:

The terminal receives the recommendation information and visual information from the server and presents them to the user. The input to this step is the response messages transmitted in Step 18. The terminal decodes the messages, parses the structured data into sections, renders text and images on the display device, arranges the information in a readable layout, and outputs a user interface through which the user can visually confirm the candidate merchandise information and the attire information.

### Step 20:

The user reviews the displayed recommendation information on the terminal and decides whether to refine the request. The input to this step is the visual display generated in Step 19. The user evaluates the outfits, skincare, and makeup suggestions, determines additional preferences or constraints, and outputs new prompt sentences such as “Please show a more casual version,” “Change the color scheme to darker tones,” or “Suggest an option for colder weather,” which become inputs to a new iteration of Steps 3 and onward.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation systems that utilize image analysis and machine learning typically perform a fixed pipeline: extraction of static user attributes from an image, followed by heuristic or score-based matching against a catalog. Such systems suffer from several technical limitations at the computing-system level. First, conventional systems generally treat image analysis, emotion recognition, database retrieval, and natural-language generation as isolated components that are not coherently integrated at the processor level. As a result, the processor often executes redundant feature extraction and independent model invocations, which leads to inefficient utilization of computing resources, increased latency, and unstable throughput in real-time scenarios such as in-store guidance using wearable display devices.

Second, conventional systems typically do not construct a unified, machine-processable context object that simultaneously encodes visual features, classified user characteristics, inferred emotion states, and usage-situation text. Instead, separate models are invoked with loosely coupled parameters, which complicates the control flow executed by the processor. This lack of a unified context causes difficulties in optimizing memory access patterns, caching intermediate results, and coordinating multiple machine learning inferences. Consequently, the processor performs unnecessary data copying and format conversions, degrading system-level performance.

Third, when generative artificial intelligence models are used, conventional systems often pass under-specified or ad-hoc prompt sentences to the models. The prompts frequently lack explicit enumeration of key attributes (e.g., skin type, color attribute, emotion state, situation context) and do not specify the required output format. This under-specification increases variability in generated outputs and forces the processor to perform complex post-processing, parsing, and error handling. The additional parsing logic imposes extra computational cost, increases memory footprint, and may cause failures in mapping generated text back to structured catalog data.

Fourth, many existing systems lack a technically robust mechanism for aligning the free-form natural-language output of a generative artificial intelligence model with structured item attribute data maintained in storage. Without a defined computational pipeline that calculates similarity between generated conditions and catalog attributes via a trained recommendation engine, the processor cannot reliably determine which catalog entries correspond to the abstract descriptions produced by the generative model. This leads to ambiguous or inconsistent recommendations, high rejection rates in downstream checks, and wasted computation on ineffective candidate items.

Fifth, conventional architectures often process recommendation generation and candidate ranking as separate, sequential stages that do not share intermediate representations. This fragmented design prevents effective optimization of database access, caching of frequently used attribute vectors, and reuse of similarity computations, which collectively limits the scalability of the system when the number of users, catalog items, or concurrent sessions increases.

Accordingly, there is a need for a computer-implemented system that technically improves the way a processor coordinates image processing, user-characteristic classification, emotion recognition, context construction, generative artificial intelligence prompting, and catalog alignment. Such a system should enable the processor to generate structured prompt sentences with explicit attribute enumeration, invoke a generative model in a controlled manner, and convert generated proposal content into concrete item information by using a trained recommendation engine, thereby reducing computational overhead, improving response time, and increasing the reliability and determinism of the recommendation pipeline at scale.

The specific processing by the specific processing unit 290 of the data processing device 12 in Application Example 2 is realized by the following means.

The present invention provides a server comprising a processor configured to provide an information acquisition interface that receives visual information and character information from a user, analyze the visual information by using an image processing library to detect a face region or a whole-body region and calculate feature values related to a skin region or a body contour by performing color space conversion and region extraction, input the feature values into a machine learning model and classify user characteristic information including at least a skin type, a color attribute, and a body type attribute, estimate user emotion information by using an emotion recognition model or an emotion recognition service on the basis of the visual information and the character information, generate context information by integrating the user characteristic information, the user emotion information, and the character information, acquire candidate information from a data storage device for searching a group of items or a group of decorations on the basis of the context information, construct a prompt sentence including an explicit enumeration of attributes comprising at least the skin type information, the color attribute information, the emotion information, and usage-situation information within the context information and including a description that specifies an output format of item recommendation content or full-body coordination recommendation content, input the prompt sentence and the candidate information into a generative artificial intelligence model to generate proposal content for item recommendations or full-body coordination recommendations according to the user characteristic information and the user emotion information, analyze text information included in the proposal content, calculate a similarity between item conditions or decoration conditions described in the text information and item attribute information or decoration attribute information stored in the data storage device by using a trained recommendation engine, rank candidates on the basis of the similarity, construct recommendation information by converting the proposal content into actual item information or decoration information according to a ranking result, and transmit the recommendation information to a terminal in a visually displayable format. This enables the processor to execute an integrated and technically optimized pipeline that unifies image analysis, user-characteristic classification, emotion recognition, prompt sentence construction for a generative artificial intelligence model, alignment of generated text with structured catalog data, and ranked recommendation delivery, thereby reducing redundant computations, improving latency and throughput, and increasing determinism and reliability of recommendation generation in computer-implemented systems.

The term “visual information” refers to digital data representing images or video frames including at least a face region or a whole-body region of a user, which are suitable for processing by an image processing library.

The term “character information” refers to digital text data provided by a user, including at least natural-language descriptions of a situation, preferences, or questions, which are suitable for processing by a language processing component.

The term “information acquisition interface” refers to a software and hardware interface through which a server receives visual information and character information from a user terminal, including at least an application programming interface or a web endpoint.

The term “image processing library” refers to a software component that performs computational operations on visual information, including at least region detection, color space conversion, and region extraction.

The term “face region” refers to a sub-region of visual information that contains at least a representation of a user's facial features detected by the image processing library.

The term “whole-body region” refers to a sub-region of visual information that contains at least a representation of a user's entire body outline detected by the image processing library.

The term “color space conversion” refers to a computational operation that transforms pixel values of visual information from one color representation scheme to another color representation scheme to facilitate analysis of color attributes.

The term “region extraction” refers to a computational operation that isolates a specified area of visual information, such as a skin region or a body contour, based on color, shape, or other detectable features.

The term “feature values” refers to numerical or categorical values calculated from visual information that characterize aspects such as color distribution, texture, shape, or geometry of a region.

The term “skin region” refers to a portion of visual information representing exposed skin of a user, which is identified by the image processing library using color or texture criteria.

The term “body contour” refers to an outline or boundary of a user's body detected in visual information, which is used to derive body-shape-related feature values.

The term “machine learning model” refers to a trained computational model that receives feature values as input and outputs predicted labels or scores, including at least classification of user characteristic information.

The term “user characteristic information” refers to a set of attributes representing physical features or style-related properties of a user derived from visual information, including at least a skin type, a color attribute, and a body type attribute.

The term “skin type” refers to a classification of a user's skin condition, such as dry, oily, combination, or normal, inferred by the machine learning model from the feature values.

The term “color attribute” refers to an attribute representing a user's color profile, including at least dominant skin tone or personal color category, inferred from color-related feature values.

The term “body type attribute” refers to an attribute representing a user's body shape category, such as petite, tall, curvy, or athletic, inferred from feature values related to the body contour.

The term “emotion recognition model” refers to a machine learning model that receives visual information or character information as input and outputs a classification or score related to a psychological state of a user.

The term “emotion recognition service” refers to a network-accessible computing service that performs emotion recognition based on input data including at least visual information or character information.

The term “user emotion information” refers to a representation of an inferred emotional state of a user, such as joy, sadness, neutrality, or another psychological state, obtained from an emotion recognition model or an emotion recognition service.

The term “context information” refers to a combined data structure that integrates user characteristic information, user emotion information, and character information to represent a comprehensive state used for recommendation processing.

The term “data storage device” refers to a storage subsystem including at least one memory or database system that stores item information, decoration information, attribute information, and candidate information.

The term “candidate information” refers to structured data representing one or more potential items or decorations retrieved from a data storage device for use in a recommendation process.

The term “item” refers to a tangible or intangible product that can be recommended to a user, including at least goods such as skincare products, clothing, or accessories.

The term “decoration” refers to an element that forms part of a visual appearance or coordination, including at least garments, accessories, or styling elements.

The term “prompt sentence” refers to a natural-language text instruction constructed on the basis of context information and candidate information, and provided as input to a generative artificial intelligence model to control generation of proposal content.

The term “generative artificial intelligence model” refers to a machine learning model that generates text or other content on the basis of input data including at least a prompt sentence, and that is trained using generative learning techniques.

The term “item recommendation content” refers to generated text or structured information that describes one or more items recommended to a user based on context information.

The term “full-body coordination recommendation content” refers to generated text or structured information that describes a combination of multiple items forming a coordinated full-body outfit for a user.

The term “proposal content” refers to a collective representation of item recommendation content and full-body coordination recommendation content output from the generative artificial intelligence model.

The term “item conditions” refers to descriptive constraints or characteristics regarding items, extracted from proposal content, that specify desired properties such as type, color, style, or usage situation.

The term “decoration conditions” refers to descriptive constraints or characteristics regarding decorations, extracted from proposal content, that specify desired properties such as style, color, or placement.

The term “item attribute information” refers to structured data fields stored in a data storage device that describe items, including at least type, color, size, style, and availability.

The term “decoration attribute information” refers to structured data fields stored in a data storage device that describe decorations, including at least type, color, style, and usage.

The term “trained recommendation engine” refers to a software component that has been trained or configured to compute similarity scores between conditions and attribute information, and to rank candidate items or decorations based on the similarity scores.

The term “recommendation information” refers to structured data that identifies actual items or decorations selected for presentation to a user, including at least identifiers, descriptions, and display parameters, derived from proposal content and candidate information.

The term “usage-situation information” refers to text or structured data describing a context of use for items or decorations, such as an event type, formality level, or time of use, provided by a user or inferred from character information.

The term “terminal” refers to an electronic device operated by a user, including at least a portable communication device, a wearable display device, or a computing device, which can transmit information to and receive recommendation information from the server.

In one embodiment, a server cooperates with one or more terminals operated by a user to provide personalized item recommendations and full-body coordination recommendations based on visual information, character information, and catalog data.

The terminal includes at least an image capture device such as a digital camera integrated into a portable communication device, a wearable display device, or a general-purpose computing device. The terminal further includes a display unit and a communication interface for establishing a network connection to the server over a wired or wireless communication network. The terminal executes an application, such as a messenger client or a web client implemented with a web browser, that enables the user to capture images and input text.

The user operates the terminal to capture visual information including at least a face image or a whole-body image. The terminal uses an operating system camera application programming interface to control the image sensor, to perform exposure and focus adjustment, and to obtain a digital image frame. The terminal stores the digital image as a compressed image file in a standard format and associates metadata such as a capture timestamp and a device identifier. The user further inputs character information such as a description of an event or usage situation through a text input interface.

The terminal transmits the visual information and the character information to the server via a network protocol such as Hypertext Transfer Protocol over Transport Layer Security. The terminal encapsulates the image file and the character information into a request payload and sends the payload to an application programming interface provided by the server.

The server comprises at least one processor, a memory, and a storage subsystem such as a relational database and file storage. The server executes software components implemented, for example, in a general-purpose programming language and linked with an image processing library, a machine learning framework, and a recommendation engine library. In one specific implementation, the server uses an image processing library such as an open-source computer vision library, a machine learning framework such as a tensor computation framework, a web framework such as a lightweight web server framework, and a machine learning toolkit such as a general-purpose numerical learning library. The server may also access external emotion recognition services exposed as network interfaces.

The server receives the visual information and the character information from the terminal through the information acquisition interface. The server stores the received image file in a file system or an object storage device and registers a corresponding record in a database table. The server stores the character information and links it with the stored image via a foreign key or another identifier.

The server uses the image processing library to analyze the visual information. The server loads the image into memory as a multi-dimensional array representing pixel values. The server converts the color space of the image from a first representation to at least one second representation, such as a hue-saturation-value space or a luminance-chrominance space. The server applies a face detection algorithm provided by the image processing library to locate a face region. The face detection algorithm uses a trained classifier such as a cascade classifier or a convolutional neural network to scan the image at multiple scales and positions. The server obtains bounding box coordinates indicating the face region and extracts a sub-image. When a whole-body image is provided, the server applies a human-body detector based on a region proposal method or a pose-estimation network to identify the whole-body region and body joints.

The server performs region extraction to identify a skin region by applying color thresholds and morphological filters in the transformed color space. The server further extracts a body contour by applying edge detection followed by contour tracing or by executing a segmentation network that outputs pixel-wise labels. The server calculates feature values from the extracted regions, including at least statistical measures of color channels, texture descriptors such as local binary patterns, shape descriptors such as aspect ratio or limb length ratios, and histogram-based descriptors of color distributions. The server stores the feature values in a feature vector with a predefined structure.

The server inputs the feature vector into a machine learning model to classify user characteristic information. In one embodiment, the machine learning model comprises a deep neural network implemented with the tensor computation framework. The neural network may include a sequence of convolutional layers, normalization layers, pooling layers, and fully connected layers. The server initializes the neural network with pre-trained weights obtained from supervised training on labeled datasets. During inference, the server passes the feature vector through the neural network, computes activations layer by layer, and obtains output probability distributions for a plurality of classes including skin type classes, color attribute classes, and body type attribute classes. The server applies an argmax operation to select the most probable class for each category. The server thus derives user characteristic information such as a skin type, a color attribute, and a body type attribute.

The server estimates user emotion information by executing an emotion recognition model or invoking an emotion recognition service. When performing local processing, the server uses a neural network model that receives the cropped face image or additional acoustic features as input and outputs probability scores for emotion classes such as joy, sadness, anger, surprise, and neutrality. The neural network may have an architecture including convolutional layers for spatial feature extraction, recurrent layers for temporal aggregation when multiple frames are used, and fully connected layers for classification. The server applies a softmax function at the output layer and selects the emotion with the highest probability. When using an external emotion recognition service, the server sends the face image to the service via an application programming interface and receives emotion scores as a response. The server may additionally apply natural language processing to the character information by using a sentiment analysis model or an external text analysis service to determine a sentiment polarity. The server combines the visual emotion scores and text sentiment scores according to predetermined weights to determine final user emotion information.

The server constructs context information by integrating the user characteristic information, the user emotion information, and the character information. The server stores the integrated data structure in memory as a context object having fields for skin type, color attribute, body type attribute, emotion label, sentiment score, and usage-situation information. The server performs normalization of the character information by executing tokenization, stop-word removal, and key phrase extraction to derive structured usage-situation information, such as “formal event”, “business meeting”, or “casual outing”.

The server retrieves candidate information from a data storage device based on the context information. The server accesses a relational database that stores item attribute information and decoration attribute information in normalized tables. The server executes database queries specifying filter conditions that match at least the skin type, color attribute, body type attribute, and usage-situation category. The server obtains a set of candidate records representing items or decorations that satisfy the filter conditions, and constructs candidate information including identifiers, category types, color codes, size information, and style tags.

The server constructs a prompt sentence to control a generative AI model. The server assembles a natural-language instruction string that explicitly enumerates key attributes from the context information, including at least the skin type information, the color attribute information, the emotion information, and the usage-situation information. The server further includes a description of the candidate information or a summary of candidate attributes. The server also describes an expected output format for the model, such as a numbered list of recommended items or a structured description of a full-body coordination. For example, the server may construct a prompt sentence such as:

“The user's skin type is dry, the user's color attribute corresponds to a bright spring-type palette, and the user's current emotion is joy. The user will attend a friend's wedding as a guest. From the following candidate items, propose three full-body outfit coordinations that enhance the joyful mood and suit a spring-type palette. For each coordination, list one dress, one pair of shoes, and one accessory, and briefly explain why the coordination matches the user's characteristics and the situation.”

In another example, the server may construct a prompt sentence such as:

“The user's body type is petite, the user's color attribute corresponds to an autumn-type palette, and the user plans a weekend casual outing. Based on the candidate items described below, propose two casual full-body coordinations in autumn-tone colors that visually balance a petite frame and provide comfort for a weekend walk. Output each coordination as a numbered item with a description of top, bottom, footwear, and accessories.” In yet another example, the server may construct a prompt sentence such as: “The user's skin type is oily, the user's color attribute corresponds to a winter-type palette, and the user will attend a business meeting. Propose three professional outfits using the candidate items that suit a winter-type palette and a formal business context. For each outfit, specify jacket, top, bottom, and shoes, and provide a short reasoning statement.”

The server inputs the constructed prompt sentence and the candidate information into a generative AI model. The generative AI model may be implemented as a transformer-based neural network trained on large-scale text datasets using unsupervised or semi-supervised learning. The server communicates with the generative AI model via an application programming interface and supplies the prompt sentence as part of the model input. The server sets control parameters such as maximum token length, sampling temperature, and top-k or top-p sampling thresholds to control output diversity and determinism. The server receives generated text from the generative AI model as a sequence of tokens representing proposal content.

The server analyzes the proposal content by applying natural language parsing and information extraction. The server identifies segments describing item conditions or decoration conditions, such as color requirements, silhouette types, material properties, or style adjectives. The server maps descriptive phrases to structured attribute constraints by using a vocabulary mapping or an embedding-based similarity measure. The server then uses a trained recommendation engine to align the item conditions with stored item attribute information. The recommendation engine may be implemented with a machine learning model trained to compute similarity scores between condition vectors and item attribute vectors. The server calculates similarity scores for each candidate item and ranks the candidate items according to the scores. The server determines final recommendation information by selecting items with similarity scores above a threshold and arranging them according to rank.

The server constructs recommendation information by associating the generated proposal content with specific items or decorations. The server creates a data structure including, for each recommended coordination or item, a reference to item identifiers, a textual explanation derived from the generative AI model, and presentation parameters such as display order, thumbnail image identifiers, and highlighting flags. The server formats the recommendation information in a representation suitable for transmission to the terminal, such as a structured document or a message object compatible with a messenger platform.

The server transmits the recommendation information to the terminal via the network. The terminal receives the recommendation information and renders it on the display. The terminal may display, for example, a list of recommended items with images, names, and explanations, or an overlay on a wearable display that presents a concise coordination suggestion in the user's field of view. The user can review the recommendation information, select items of interest, or request alternative suggestions.

The server and the terminal thereby implement a technical pipeline that improves computer technology rather than merely automating a human mental process. The server reduces redundant computations by reusing feature vectors and context objects across multiple processing components, thereby improving cache locality and memory usage. The server reduces communication load by transmitting compact representations, such as identifiers and attribute vectors, to the generative AI model instead of entire images or full catalogs. The explicit structure of the prompt sentence and the explicit enumeration of attributes constrain the generative AI model to produce outputs in a predictable format, which reduces post-processing complexity and parsing errors. The use of a trained recommendation engine to align generated conditions with catalog attributes ensures deterministic mapping, reduces mismatches, and lowers the rate of failed recommendations.

The specific neural network architectures and training methods further enhance technical performance. During training of the classification and emotion recognition models, the server or an offline training system uses stochastic gradient descent or a variant thereof to minimize a loss function such as cross-entropy. The system updates model weights using back-propagation, applies regularization techniques such as dropout, and uses data augmentation such as random cropping, color jittering, and geometric transformations to increase robustness. The recommendation engine may be trained by minimizing a ranking loss or a metric-learning loss on historical user interaction data. These concrete training procedures result in models that produce accurate and stable predictions within the described pipeline.

The server operates according to specific rules and non-conventional sequences distinct from manual operations. The server forms a context object as a unified data structure, constructs a prompt sentence using a predefined template with explicit attribute enumeration, invokes the generative AI model with constrained control parameters, and then resolves generated text to concrete items by computing attribute similarity with a trained engine. This sequence is not a mere automation of human decision making but an engineered cooperation of multiple specialized models and data structures that yields improved processing speed, increased recommendation accuracy, and reduced resource consumption.

In another embodiment, the server may vary the image processing techniques while preserving the core integrated pipeline. For example, the server may replace the classical region extraction with a semantic segmentation network that directly outputs skin masks and clothing masks. In another variation, the server may include additional sensors, such as depth cameras, to refine body contour estimation and generate three-dimensional body type attributes. In yet another variation, the server may use different generative AI models, such as models specialized for fashion text, while still constructing prompt sentences that enumerate skin type, color attribute, emotion, and usage-situation information.

The terminal may also take different forms. In one variant, the terminal is a head-mounted display with an integrated camera and a short-range communication module. In another variant, the terminal is a tablet or kiosk installed within a physical store. In each case, the terminal acquires visual information under the control of the server's interface and displays recommendation information according to the server's formatting.

Through these embodiments and variations, the server, the terminal, and the user cooperate to realize a technically improved recommendation system in which image analysis, user-characteristic classification, emotion recognition, context construction, generative AI model prompting, and catalog alignment are integrated into a unified, optimized pipeline, yielding enhanced computational efficiency, improved accuracy, and stable operation even under high load.

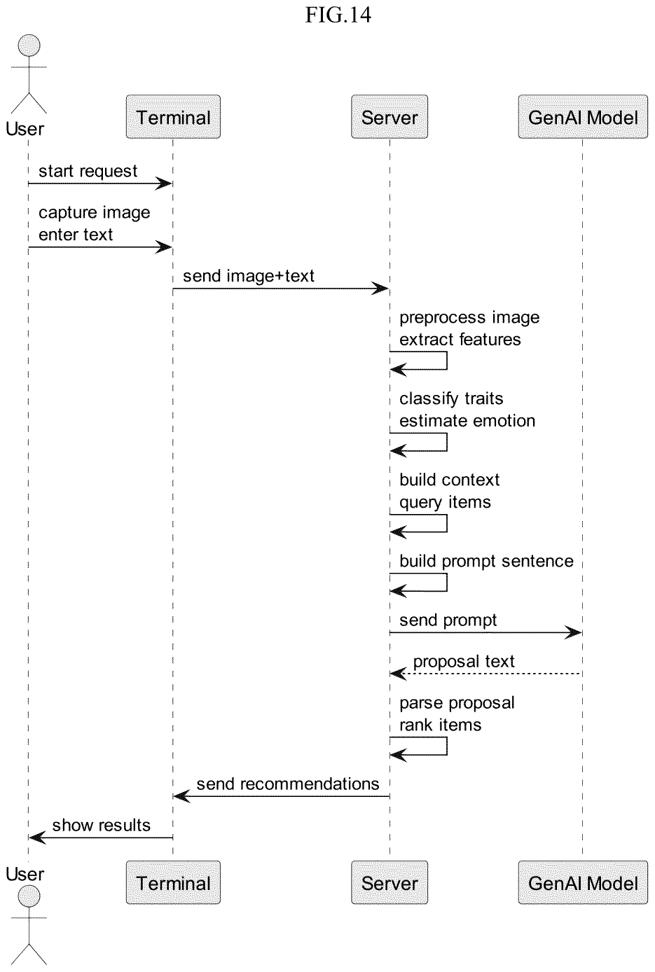

The following describes the processing flow using FIG. 14.

### Step 1:

The user initiates a recommendation request.

The user operates the terminal to launch an application and selects a function such as “skin analysis,” “outfit suggestion,” or “in-store recommendation.”

Input: No structured input yet; the user's intent to start a session.

Output: A UI state on the terminal that is ready to capture visual information and character information.

### Step 2:

The terminal captures visual information.

The terminal activates a camera module via an operating system camera interface and displays a preview to the user.

The user positions their face or whole body in front of the camera and confirms a capture operation.

The terminal captures one or more frames from the image sensor, compresses a selected frame into a digital image file, and stores metadata such as timestamp and device identifier.

Input: Raw sensor data from the camera.

Output: A compressed image file representing visual information and associated capture metadata.

### Step 3:

The terminal acquires character information from the user.

The terminal displays a text input field for usage-situation information or questions.

The user enters character information such as “I will attend a friend's wedding next weekend.

What dress should I wear?” or “Please suggest an outfit for a weekend casual outing.” The terminal stores the entered text and associates it with the captured image.

Input: Keystrokes or speech-to-text results from the user.

Output: A text string representing character information linked to the image file.

### Step 4:

The terminal transmits visual information and character information to the server.

The terminal constructs a request payload including the image file, the character information, and metadata (device ID, app version, session ID).

The terminal serializes the payload into a format such as multipart/form-data or JSON with a binary attachment.

The terminal sends the payload to an endpoint of the server over a secure communication protocol.

Input: The image file, character information, and metadata stored on the terminal.

Output: A network request containing the payload delivered to the server.

### Step 5:

The server receives and stores the input data.

The server accepts the incoming request at an information acquisition interface and validates structure and size constraints.

The server extracts the image file and character information from the request.

The server stores the image file in a storage device and inserts a database record containing paths and character information linked to a session identifier.

Input: The request payload from the terminal.

Output: Stored visual information, stored character information, and a database entry representing a new analysis session.

### Step 6:

The server performs image preprocessing and region detection.

The server loads the stored image into memory as a pixel matrix using an image processing library.

The server converts the pixel values from a first color space to another color space suited for skin detection, such as a hue-saturation-value space, by applying a color transformation formula to each pixel.

The server applies a face or human-body detector to the pixel matrix to compute bounding boxes for a face region or a whole-body region.

The server crops the pixel matrix according to the bounding boxes and resizes the sub-images to standardized dimensions.

Input: The stored image file for the session.

Output: One or more normalized sub-images representing a face region or a whole-body region, and associated bounding box coordinates.

### Step 7:

The server extracts feature values from the detected regions.

The server applies region extraction methods to isolate skin regions within the face or body sub-images using color thresholds and morphological operations.

The server computes statistical color features such as mean hue, saturation, and brightness, and computes texture features such as local binary patterns over the skin region.

The server identifies a body contour from the whole-body region using edge detection and contour tracing, and calculates shape features including height-to-width ratio, limb length ratios, and silhouette descriptors.

The server stores these computed quantities in a structured feature vector.

Input: Normalized sub-images of the face and/or whole body.

Output: A feature vector containing numerical feature values for color, texture, and shape.

Step 8: The server classifies user characteristic information using a machine learning model.

The server loads pre-trained model parameters for a classification neural network from persistent storage.

The server normalizes the feature vector by applying scaling or whitening operations and then feeds the normalized vector into the neural network as an input tensor.

The server executes the neural network forward pass to compute activations across layers and outputs probability distributions over predefined classes for skin type, color attribute, and body type attribute.

The server selects the class with the highest probability for each category and forms user characteristic information.

Input: The feature vector generated in Step 7.

Output: User characteristic information including values for skin type, color attribute, and body type attribute.

### Step 9:

The server estimates user emotion information.

The server crops the face region sub-image from the data obtained in Step 6 and resizes it to match the input dimensions of an emotion recognition model.

The server passes the sub-image to a neural network-based emotion classifier or transmits it to an emotion recognition service.

The server receives emotion scores for multiple emotion categories and computes the dominant emotion label by selecting the highest score.

The server may analyze the character information using a sentiment analysis model to obtain a sentiment polarity score.

The server combines the emotion label and sentiment polarity using predefined weighting rules to derive user emotion information.

Input: The cropped face sub-image and the character information.

Output: User emotion information represented by an emotion label and optionally a sentiment score.

### Step 10:

The server constructs context information.

The server creates a context object that stores the user characteristic information, the user emotion information, and the character information in a unified data structure.

The server performs natural language preprocessing on the character information to extract key phrases representing usage-situation categories.

The server populates fields in the context object, such as situation type, formality level, and time frame, using the extracted key phrases.

Input: User characteristic information from Step 8, user emotion information from Step 9, and raw character information from Step 5.

Output: A context object that encodes attributes including skin type, color attribute, body type attribute, emotion label, and usage-situation information.

### Step 11:

The server retrieves candidate information from a data storage device.

The server formulates query conditions using fields of the context object, such as required skin type compatibility, color palette compatibility, size constraints, and usage-situation tags.

The server executes parameterized queries against one or more database tables storing item attribute information and decoration attribute information.

The server filters out items that do not satisfy the conditions and obtains a collection of candidate records.

The server constructs candidate information by assembling identifiers, category types, color codes, size attributes, and style descriptors from the retrieved records.

Input: The context object containing user characteristics and situation attributes.

Output: Candidate information representing a filtered list of items or decorations suitable for further ranking.

### Step 12:

The server constructs a prompt sentence for a generative AI model.

The server reads relevant fields from the context object, including the skin type, color attribute, body type attribute, emotion label, and usage-situation information.

The server generates a natural-language string that explicitly enumerates these attributes and describes the target of the recommendation.

The server incorporates a summary of candidate information, such as item categories and colors, into the string.

The server appends an instruction specifying the desired output format, for example a numbered list of coordinated outfits with explanations.

Input: The context object and the candidate information.

Output: A prompt sentence that encodes the context and desired output format to control the generative AI model.

### Step 13:

The server invokes the generative AI model and obtains proposal content.

The server sends the prompt sentence to the generative AI model via an application programming interface and sets generation parameters such as maximum length and sampling temperature.

The server receives generated text from the generative AI model, where the text describes one or more item recommendation content segments or full-body coordination recommendation content segments.

The server stores the generated text as proposal content associated with the session.

Input: The prompt sentence created in Step 12.

Output: Proposal content in the form of generated text describing recommended items and coordinations.

### Step 14:

The server parses the proposal content and extracts item conditions and decoration conditions.

The server applies a natural language parsing component to segment the generated text into separate recommendations and explanatory phrases.

The server identifies descriptive expressions that specify item conditions or decoration conditions, such as color constraints, style types, or garment categories.

The server maps each expression to a structured condition vector by using a vocabulary mapping or an embedding-based similarity function between words and attribute labels.

Input: The proposal content generated in Step 13.

Output: Structured condition vectors representing item conditions and decoration conditions for each recommendation.

### Step 15:

The server ranks candidates using a trained recommendation engine.

The server retrieves attribute vectors for the candidate items from the data storage device, including attributes such as type, color, size, and style tags.

The server inputs the condition vectors and candidate attribute vectors into a trained recommendation engine that computes similarity scores.

The server calculates, for each candidate item, a similarity score relative to each set of conditions by applying a learned distance function or ranking model.

The server sorts candidates by similarity score for each recommendation slot and selects top-ranked items as recommended items.

Input: Condition vectors from Step 14 and candidate attribute vectors derived from Step 11.

Output: Ranked lists of candidate items with associated similarity scores and selected items for each recommendation.

### Step 16:

The server constructs recommendation information.

The server associates the selected items with corresponding textual explanations extracted from the proposal content.

The server creates a structured recommendation object that holds, for each recommended coordination or item, an item identifier, a title, a descriptive text, price information if available, and pointers to image resources.

The server determines presentation order and grouping based on similarity scores and context importance, such as prioritizing items that match both emotion and usage-situation constraints.

Input: Selected items and explanations from Steps 13 and 15.

Output: Recommendation information formatted as a structured object ready for transmission.

### Step 17:

The server transmits the recommendation information to the terminal.

The server serializes the recommendation information into a message format supported by the communication protocol or the application platform.

The server sends the message to the terminal by addressing the session or user identifier.

The server may log the transmitted recommendation information for analysis and future model improvement.

Input: The structured recommendation information from Step 16.

Output: A network response or push message containing recommendation information delivered to the terminal.

### Step 18:

The terminal displays the recommendation information to the user.

The terminal receives the response from the server and parses the structured data to extract item identifiers, texts, and image references.

The terminal loads associated images from local cache or via additional network requests and composes a user interface view.

The terminal presents the recommendations as a list, grid, or overlay, showing each item's image, name, and explanation.

Input: The recommendation information received from the server.

Output: A rendered display on the terminal that is visually perceivable by the user.

Step 19: The user interacts with the displayed recommendations.

The user views the recommended items and selects items of interest, dismisses others, or enters additional feedback text such as “show more casual options” or “I prefer darker colors” The terminal captures the user's selection signals and feedback text and prepares them as interaction data.

The terminal sends the interaction data back to the server for logging and potential refinement of further recommendations.

Input: The visual display and the user's preferences or actions.

Output: Feedback data transmitted to the server, including selections, rejections, and textual comments.

### Step 20:

The server updates preference data and optionally refines recommendations.

The server stores the received feedback in a user preference store, associating positive or negative signals with corresponding item attributes and conditions.

The server may reconstruct a new context object that incorporates the updated preferences, such as “prefers darker colors” or “prefers casual styles.”

The server may generate an updated prompt sentence that reflects the new preferences, invoke the generative AI model again, and repeat Steps 13 to 17 to provide refined recommendations.

Input: Feedback data from the terminal and existing context or profile data.

Output: Updated user preference data and, when refinement is performed, new recommendation information.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

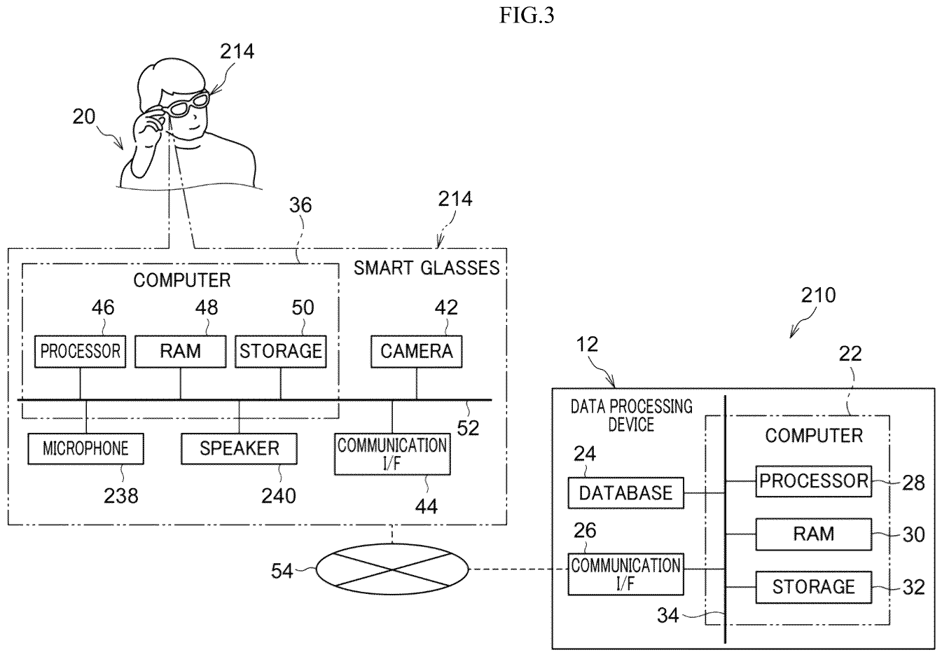

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

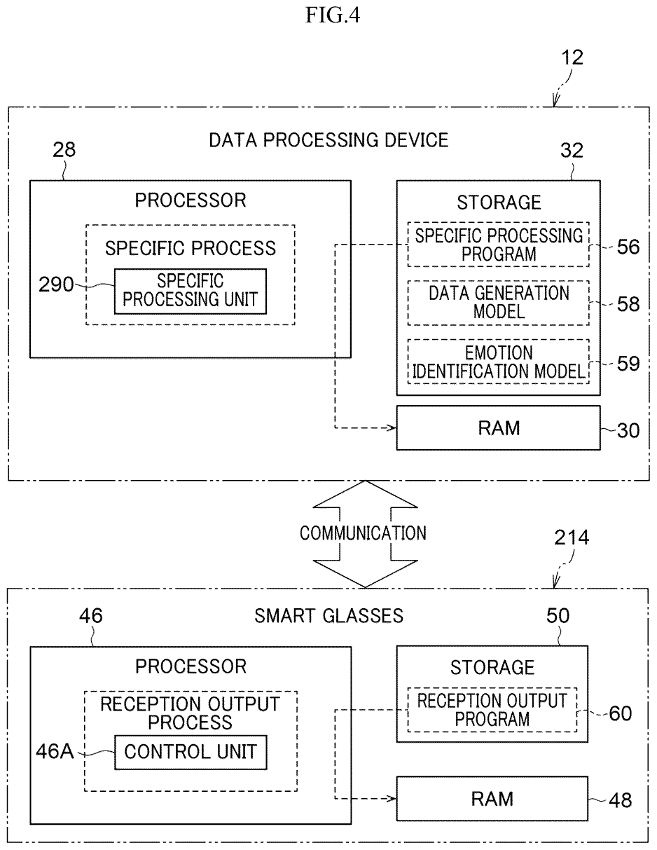

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

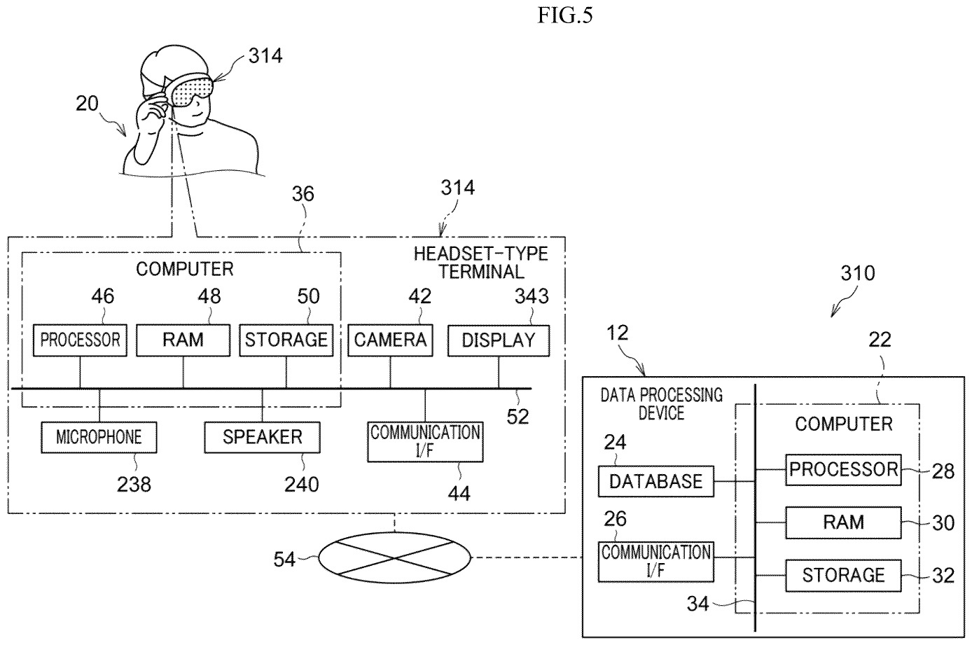

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

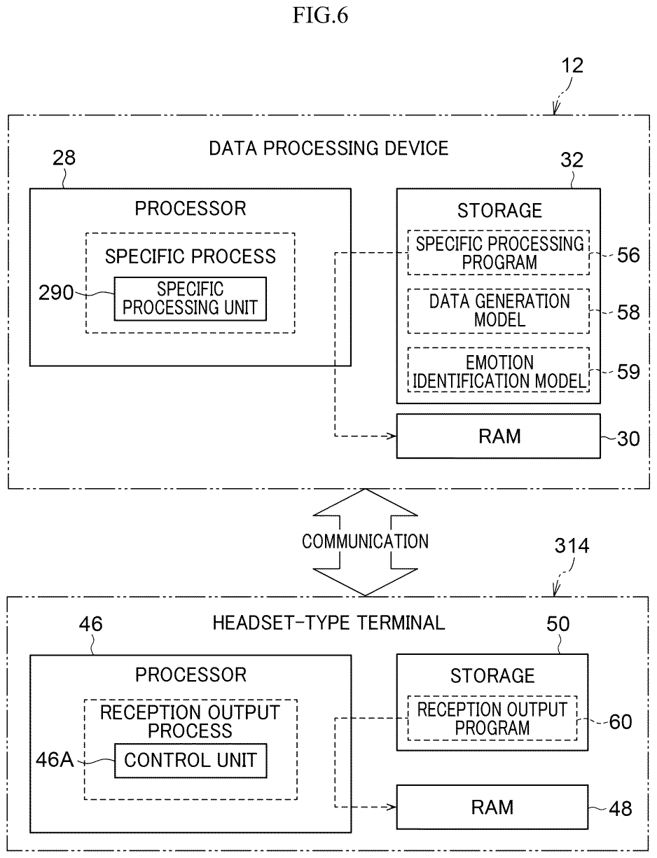

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

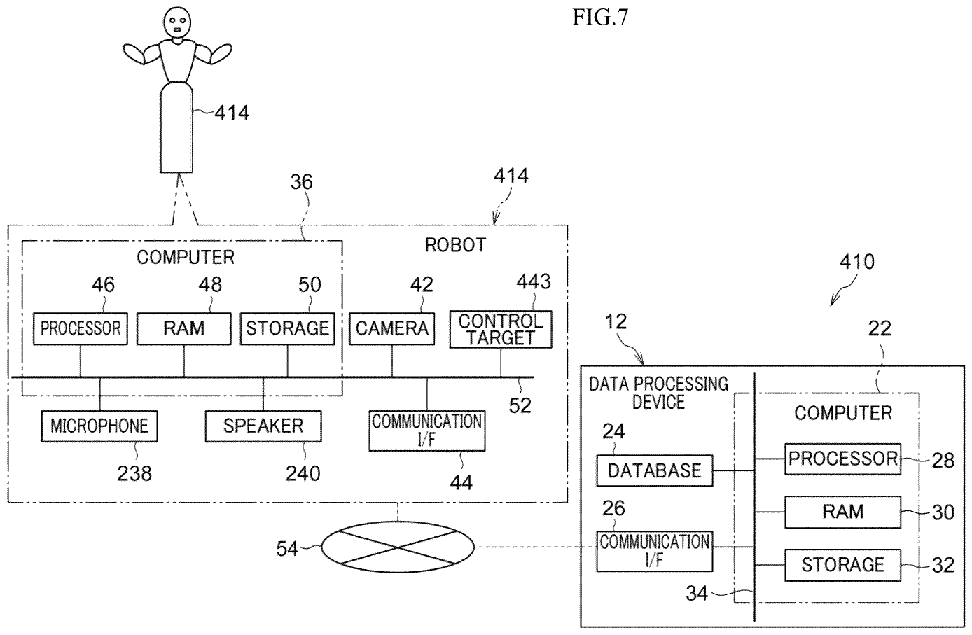

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

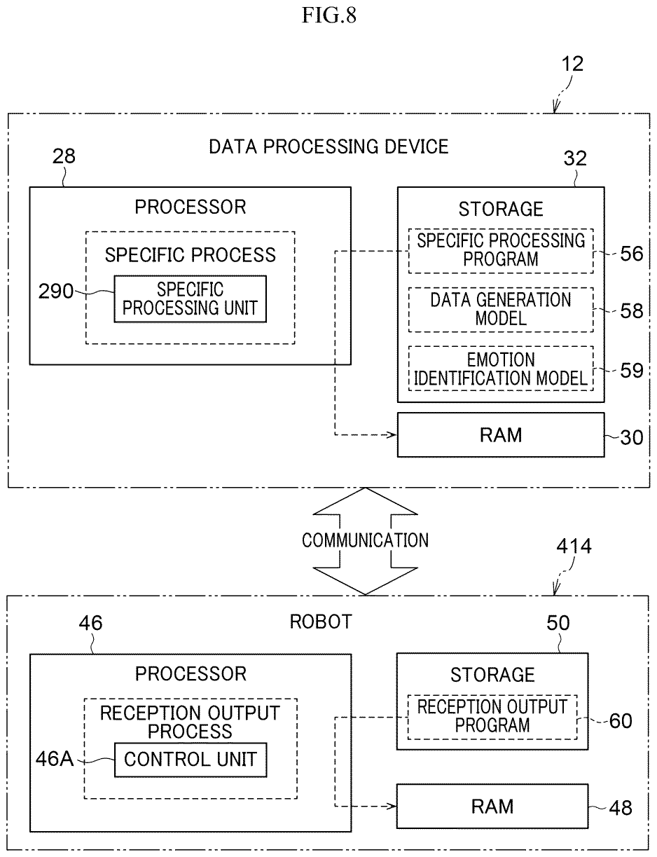

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414.

A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

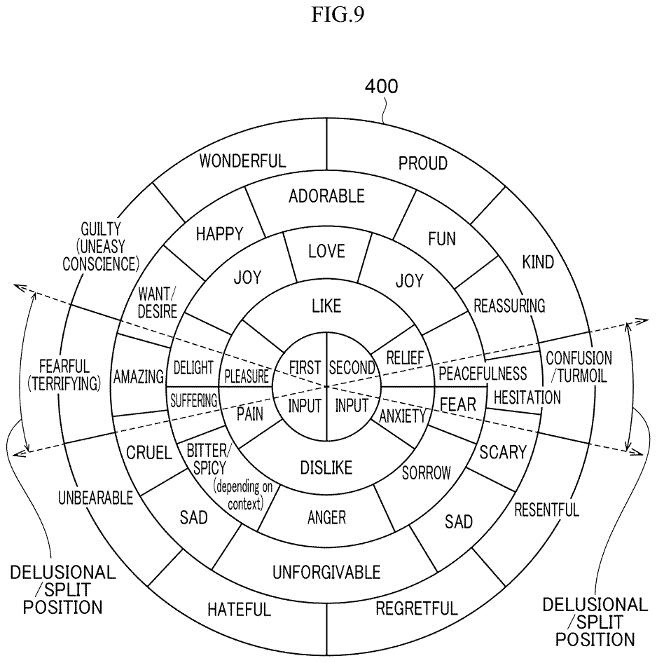

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

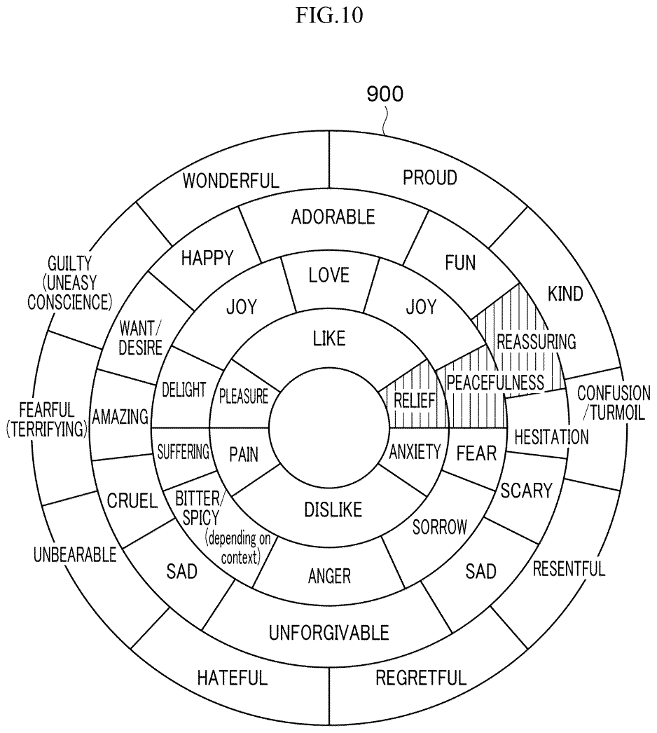

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure.

This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a communication interface, image information and situation information transmitted from a user terminal through a communication network; and
execute an image analysis process on the image information by using an external image analysis function to obtain color feature information and face region information, and extract user characteristic information including skin condition information and appearance color attribute information based on the color feature information and the face region information; and generate, on the basis of the user characteristic information and the situation information, a prompt sentence to be input to a generative artificial intelligence model by combining template information with the user characteristic information and the situation information through a text generation process; and
input the prompt sentence into the generative artificial intelligence model and, based on numerical computation performed by the generative artificial intelligence model, obtain product candidate information including clothing product information, cosmetic product information, and skin care product information; and
select, based on attribute information included in the product candidate information, a plurality of product information items from a group of product information stored in a storage device, and structure the plurality of product information items as recommendation product information associated with the product candidate information; and
acquire image information corresponding to the recommendation product information from the storage device, and format the recommendation product information and the image information as response information transmittable to the user terminal; and transmit the response information to the user terminal so that the recommendation product information and the image information are presented to a user through the user terminal.

### (Supplementary 2)

The system according to supplementary 1,
wherein the processor is configured to
classify the color feature information obtained by the image analysis process by using a classification function, assign one of a plurality of color attribute categories as the appearance color attribute information, and dynamically change an expression content and product types in the prompt sentence based on an assignment result and the situation information.

### (Supplementary 3)

The system according to supplementary 1,
wherein the processor is configured to
use the product candidate information output from the generative artificial intelligence model to acquire, as visual information corresponding to each product included in the recommendation product information, still image information or moving image information, and transmit the visual information to the user terminal so that the user can visually confirm the products via a display function of the user terminal.

### Application Example 1

### (Supplementary 1)

A system comprising a processor,
wherein the processor is configured to
receive, via an input/output device, image data and associated information from a user, the image data including a facial image or a full-body image captured by an information processing terminal operated by the user and transmitted over a communication path, perform preprocessing on the received image data by using an image processing program to convert the image data to a predetermined resolution and color space, detect and crop a subject region, and generate a numerical feature vector including color features and shape features,
input the numerical feature vector and the preprocessed image data into a generative artificial intelligence model including a machine learning model, and estimate user characteristic information relating to an appearance of the user, the user characteristic information including at least one of skin condition, color tendency, and body shape information, generate, on the basis of the estimated user characteristic information and usage-purpose information input by the user, a prompt sentence expressed in a natural language, the prompt sentence being configured to instruct selection conditions and explanation conditions for a product or a service,
search, on the basis of the user characteristic information and the prompt sentence, product attribute information stored in a product information storage device, extract candidate products that match the user characteristic information, and rank the candidate products according to a relevance degree,
generate, by using a natural language processing generative artificial intelligence model and structured data including the candidate products and the user characteristic information as input, an explanation text including at least one of recommendation reasons, usage methods, and coordination proposals for the candidate products, and
generate output data for transmitting, as visual information, the candidate products and the explanation text to the information processing terminal, and generate presentation information that enables the user to visually confirm the candidate products on a display device of the information processing terminal.

### (Supplementary 2)

The system according to supplementary 1,
wherein the processor is configured to execute a query process on the product information storage device on the basis of the user characteristic information, narrow down products by using attributes including at least one of skin condition attributes, color tendency attributes, and usage-scene attributes, calculate relevance scores of the candidate products on the basis of output from the generative artificial intelligence model, and reorder the candidate products according to the relevance scores.

### (Supplementary 3)

The system according to supplementary 1,
wherein the processor is configured to generate an input sentence for the generative artificial intelligence model by adding attribute information relating to the candidate products and the user characteristic information to the prompt sentence, input the input sentence to the generative artificial intelligence model, generate, for each of the candidate products, an explanation text including a personalized recommendation reason, and associate the explanation text with the corresponding candidate product in the presentation information.

### Example 2

### (Supplementary 1)

A system comprising a processor,
wherein the processor is configured to
receive, via a communication network, request information including image information and a prompt sentence from an information processing terminal operated by a user,
perform image analysis processing on the received image information to detect a body region included in the image information, calculate color information and brightness information based on pixel information corresponding to the body region, and identify attribute information including user characteristic information based on the color information and the brightness information,
perform natural language processing on the prompt sentence to extract situation information and request content information from the prompt sentence,
generate, based on context information including the attribute information, the situation information, and the request content information, a prompt sentence to be input to a generative artificial intelligence model,
input the prompt sentence to the generative artificial intelligence model and cause the generative artificial intelligence model to generate response information including proposal information corresponding to the context information,
generate recommendation information including candidate merchandise information and attire information based on the proposal information included in the response information, and
transmit the recommendation information to the information processing terminal so that the candidate merchandise information and the attire information are displayed on the information processing terminal.

### (Supplementary 2)

The system according to supplementary 1,
wherein the processor is configured to
search a group of merchandise information stored in a storage device based on the attribute information and the situation information, and extract, as the candidate merchandise information, merchandise information consistent with the proposal information obtained from the generative artificial intelligence model.

### (Supplementary 3)

The system according to supplementary 1,
wherein the processor is configured to
generate visual information representing at least part of the candidate merchandise information and the attire information constituting the recommendation information, and transmit the visual information to the information processing terminal so that the user can visually confirm the candidate merchandise information and the attire information via a display device of the information processing terminal.

### Application Example 2

### (Supplementary 1)

A system comprising a processor,
wherein the processor is configured to
provide an information acquisition interface that receives visual information and character information from a user,
analyze the visual information by using an image processing library to detect a face region or a whole-body region, and calculate feature values related to a skin region or a body contour by performing color space conversion and region extraction,
input the feature values into a machine learning model and classify user characteristic information including at least a skin type, a color attribute, and a body type attribute, estimate user emotion information by using an emotion recognition model or an emotion recognition service on the basis of the visual information and the character information, acquire candidate information from a data storage device for searching a group of items or a group of decorations on the basis of context information obtained by integrating the user characteristic information, the user emotion information, and the character information, construct a prompt sentence including the context information and the candidate information, input the prompt sentence into a generative artificial intelligence model, and cause the generative artificial intelligence model to generate proposal content for item recommendations or full-body coordination recommendations according to the user characteristic information and the user emotion information,
associate the generated proposal content with the candidate information and construct recommendation information by converting the generated proposal content into actual item information or decoration information, and
transmit the recommendation information to a terminal and cause the recommendation information to be output in a visually displayable format at the terminal.

### (Supplementary 2)

The system according to supplementary 1,
wherein the processor is configured to
include in the prompt sentence an explicit enumeration of attributes comprising at least skin type information, color attribute information, emotion information, and usage-situation information within the context information, and to include in the prompt sentence a description that specifies an output format of the item recommendation content or the full-body coordination recommendation content generated by the generative artificial intelligence model.

(Supplementary 3)

The system according to supplementary 1,
wherein the processor is configured to
analyze text information output from the generative artificial intelligence model, calculate a similarity between item conditions or decoration conditions described in the text information and item attribute information or decoration attribute information stored in the data storage device by using a trained recommendation engine, rank candidates on the basis of the similarity, and determine the recommendation information on the basis of a ranking result.

What is claimed is:

1. A system comprising:
circuitry configured to:
receive, via a packet-switched network, image data and context data transmitted from a terminal device;
perform an analysis process on the image data by executing a region detection operation to identify a subject region within the image data and by computing a feature vector comprising color feature values and spatial feature values based on pixel information corresponding to the subject region;
input the feature vector into a trained classification model to determine attribute information associated with the image data, the attribute information comprising at least a first classification label and a second classification label;
generate, based on the attribute information and the context data, an input sequence for a generative model by populating template data with the attribute information and the context data through a text assembly process;
execute the generative model on the input sequence to produce candidate data comprising a plurality of candidate entries each associated with respective entry attributes;
retrieve, from a storage device, a plurality of data records matching the entry attributes of the candidate entries, and structure the plurality of data records as result data associated with the candidate data;
acquire reference data corresponding to the result data from the storage device and format the result data and the reference data as response data; and
transmit the response data to the terminal device via the packet-switched network.

2. The system according to claim 1, wherein the circuitry is configured to perform a color space conversion on the image data prior to computing the feature vector, the color space conversion transforming pixel values from a first color representation to a second color representation.

3. The system according to claim 1, wherein the region detection operation comprises executing a trained neural network on the image data to compute bounding box coordinates identifying the subject region, and cropping the image data according to the bounding box coordinates.

4. The system according to claim 1, wherein the feature vector comprises statistical measures including at least a mean value and a variance value computed from color channel distributions within the subject region.

5. The system according to claim 1, wherein the trained classification model comprises a feedforward neural network trained using a supervised learning method with a cross-entropy loss function, the feedforward neural network outputting probability distributions over a plurality of predefined categories for each of the first classification label and the second classification label.

6. The system according to claim 5, wherein the circuitry is configured to select, for each of the first classification label and the second classification label, a category having a highest probability value from the respective probability distribution, and to store the selected categories as the attribute information in association with a session identifier.

7. The system according to claim 1, wherein the template data comprises a plurality of text patterns each including placeholder fields, and the circuitry is configured to select a text pattern based on a presence or absence of specific values within the attribute information and the context data, and to replace the placeholder fields with corresponding values from the attribute information and the context data.

8. The system according to claim 1, wherein the circuitry is configured to normalize the image data to a predetermined resolution prior to performing the analysis process, the normalizing comprising resizing the image data to a standardized pixel dimension.

9. The system according to claim 1, wherein executing the generative model comprises tokenizing the input sequence into token identifiers based on a vocabulary, mapping the token identifiers to embedding vectors, and processing the embedding vectors through a multi-layer transformer architecture to generate the candidate data.

10. The system according to claim 9, wherein the multi-layer transformer architecture comprises attention layers performing matrix multiplications, layer normalization operations, and non-linear activation functions.

11. The system according to claim 1, wherein the circuitry is configured to parse the candidate data to extract the plurality of candidate entries, each candidate entry comprising at least a category field, a color attribute field, and a constraint field.

12. The system according to claim 1, wherein retrieving the plurality of data records comprises computing similarity scores between the entry attributes of the candidate entries and attribute fields of data records stored in the storage device, and selecting data records having similarity scores satisfying a threshold condition.

13. The system according to claim 12, wherein computing the similarity scores comprises applying a scoring algorithm that combines a plurality of weighted measures including at least a category match measure and an attribute compatibility measure.

14. The system according to claim 1, wherein the attribute information further comprises a third classification label determined by inputting the feature vector into a second trained classification model distinct from the trained classification model used for the first classification label and the second classification label.

15. The system according to claim 1, wherein the circuitry is configured to estimate emotion information based on at least one of the image data and the context data by executing an emotion recognition model, and to incorporate the emotion information into the input sequence for the generative model.

16. The system according to claim 15, wherein the emotion recognition model comprises a neural network that receives a cropped portion of the image data corresponding to the subject region and outputs probability scores for a plurality of emotion categories.

17. The system according to claim 1, wherein the circuitry is configured to generate, using a natural language processing model and structured data comprising the candidate entries and the attribute information as input, explanation data describing associations between the attribute information and the candidate entries, and to include the explanation data in the response data.

18. A system comprising:
circuitry configured to:
receive image data and descriptor data from a terminal device via a packet-switched network;
perform preprocessing on the image data using an image processing module to convert the image data to a standardized resolution and a standardized color space, detect a subject region within the preprocessed image data, and generate a numerical feature vector from the subject region;
input the numerical feature vector into a machine learning model to estimate attribute data relating to characteristics represented in the image data;
generate, based on the attribute data and the descriptor data, a prompt sequence for a generative artificial intelligence model, the prompt sequence specifying selection criteria and output format constraints;
input the prompt sequence into the generative artificial intelligence model to obtain candidate information;
search attribute records stored in a data store based on the attribute data and the candidate information, extract matching records, and rank the matching records according to a relevance measure;
generate, using a language generation model receiving the matching records and the attribute data as input, descriptive data associated with the matching records; and
transmit response information comprising the matching records and the descriptive data to the terminal device via the packet-switched network.

19. The system according to claim 18, wherein the circuitry is configured to construct an extended input for the language generation model by appending attribute fields of the matching records and the attribute data to the prompt sequence, and to generate the descriptive data by processing the extended input through the language generation model.

20. A method performed by circuitry, the method comprising:
receiving, via a packet-switched network, image data and context data from a terminal device;
performing an analysis process on the image data by executing a region detection operation to identify a subject region and by computing a feature vector comprising color feature values and spatial feature values based on pixel information of the subject region;
inputting the feature vector into a trained classification model to determine attribute information comprising at least a first classification label and a second classification label;
generating, based on the attribute information and the context data, an input sequence for a generative model by populating template data with the attribute information and the context data;
executing the generative model on the input sequence to produce candidate data;
retrieving, from a storage device, data records matching entry attributes of the candidate data, and structuring the data records as result data;
formatting the result data as response data; and
transmitting the response data to the terminal device via the packet-switched network.
